(19) United States
(12) Patent Application Publication
(10) Pub. No.: US 2014/0093741 A1
(43) Pub. Date: Apr. 3, 2014

(54) HARDCOAT FILM, METHOD FOR FABRICATING HARDCOAT FILM, ANTIREFLECTION FILM, POLARIZING PLATE, AND IMAGE DISPLAY DEVICE

(71) Applicant: FUJIFILM Corporation, Tokyo (JP)

(72) Inventors: Kenichi FUKUDA, Minami-Ashigara-shi (JP); Yutaka ADEGAWA, Minami-Ashigara-shi (JP)

(73) Assignee: FUJIFILM Corporation, Tokyo (JP)

(21) Appl. No.: 14/040,123

(22) Filed: Sep. 27, 2013

(30) Foreign Application Priority Data
Sep. 28, 2012 (JP) 2012-217624
Oct. 12, 2012 (JP) 2012-227515

(51) Int. Cl. G02B 1/11; G02B 1/10

(52) U.S. Cl. CPC G02B 1/111; G02B 1/105
USPC 428/508; 428/523; 428/516; 359/601

(57) ABSTRACT

There is provided a hardcoat film including a hardcoat layer provided at least one surface-side of a transparent support, wherein the hardcoat layer is formed from a hardcoat layer-forming composition containing a compound having a cyclic aliphatic hydrocarbon group and three or more ethylenically unsaturated double bond groups in a molecule of the compound, and a polymerization initiator.

### CROSS-REFERENCE TO RELATED APPLICATION(S)

The present application claims priority from Japanese Patent Application Nos. 2012-217624 filed on Sep. 28, 2012, and 2012-227515 filed on Oct. 12, 2012, the entire contents of which are incorporated herein by reference.

### BACKGROUND

1. Field

The present invention relates to a hardcoat film, a method for fabricating a hardcoat film, an antireflection film, a polarizing plate, and an image display device.

2. Description of the Related Art

A liquid crystal display device (LCD) is thin and lightweight and has low electric power consumption, and thus, is widely used. The liquid crystal display device includes a liquid crystal cell and a polarizing plate. The polarizing plate usually includes a protective film and a polarization film, and is obtained by dyeing the polarization film made from a polyvinyl alcohol film with iodine, stretching the dyed polarization film, and then layering the protective film on both surfaces thereof. In a transmissive liquid crystal display device, in general, this polarizing plate is attached to both sides of a liquid crystal cell, and furthermore, one or more optically-compensatory films (phase difference films) are disposed inside (at the liquid crystal cell side) the two polarizing plates. Further, the optically-compensatory film is used as the protective film in some cases. As the protective film of the polarizing plate, including an optically-compensatory film, a cellulose acylate film is widely used.

In recent years, the liquid crystal display device has been distributed as a TV set, and has been larger and thinner.

As means of making a liquid crystal display device thinner, the thickness of a glass support constituting a liquid crystal cell is set to 0.5 mm or less, or a polarizing plate bonded to both sides thereof is made thinner. As the liquid crystal display device becomes thin, rigidity of a liquid crystal panel is reduced. In addition, the liquid crystal panel becomes large, and thus the panel is easily bent structurally. Accordingly, a problem resulting from warpage of the panel caused by change in moisture permeability of the use environment has been exposed.

Japanese Patent Application Laid-Open No. 2008-256747 describes that it is possible to suppress deterioration in quality of a display image caused by a change in environment of a liquid crystal display device by adopting a low moisture permeable film as a surface film of a polarizing plate.

Japanese Patent Application Laid-Open No. 2006-083225 describes a low moisture permeable film obtained by being coated with a curable composition, which contains a compound having a specific cyclic aliphatic hydrocarbon group and two ethylenically unsaturated double bond groups in a molecule thereof, on a transparent support film, and curing the composition.

The warpage results from expansion and contraction due to a change in moisture content of a polarization film made from a polyvinyl alcohol film which is a polarizer of a polarizing plate in the liquid crystal display device. It is thought that since expansion and contraction of the polarizer on the viewing side and the backlight side, which results from a change in temperature and humidity of the environment in which the liquid crystal display device is placed, are slightly different from each other due to the influence of the backlight or a case, expansion and contraction in the both-sided polarizing plate is asymmetrical, and thereby leading to the warpage. In order to solve the problem, it is thought to be effective to suppress the polarizer from being expanded and contracted by reducing moisture permeability of the protective film in the polarizing plate, and thus various studies have been made.

However, there is a need for a surface film having surface hardness much higher than that of a cured layer of the film obtained by the method, and low moisture permeability.

In consideration of the above-described matters, the object of the present invention is to provide a hardcoat film having low moisture permeability, sufficient surface hardness, excellent display image quality and excellent productivity.

The present inventors have intensively studied, and as a result, have found that all the aforementioned problems may be solved by layering a hardcoat layer obtained by being coated with a curable composition, which contains a compound having a cyclic aliphatic hydrocarbon group and three or more ethylenically unsaturated double bond groups in a molecule thereof, on a transparent support film, and curing the composition, thereby completing the present invention.

### SUMMARY

The problems of the present invention may be achieved by the following configuration.

(1) A hardcoat film including:

a hardcoat layer provided at least one surface-side of a transparent support,

wherein the hardcoat layer is formed from a hardcoat layer-forming composition containing a compound having a cyclic aliphatic hydrocarbon group and three or more ethylenically unsaturated double bond groups in a molecule of the compound, and a polymerization initiator.

(2) The hardcoat film according to (1),

wherein the cyclic aliphatic hydrocarbon group is a group represented by Formula (I), (II) or (IV):

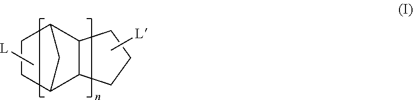

wherein in Formula (I), each of L and L′ independently represents a di- or higher valent linking group, and both L and L′ are not divalent at the same time, and n represents an integer of 1 to 3:

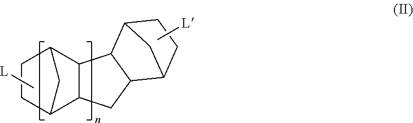

wherein in Formula (II), each of L and L′ independently represents a di- or higher valent linking group, and both L and L′ are not divalent at the same time, and n represents an integer of 1 to 2:

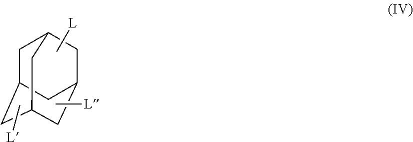

wherein in Formula (IV), each of L, L′ and L″ independently represents a di- or higher valent linking group.

(3) The hardcoat film according to (1),

wherein the compound having a cyclic aliphatic hydrocarbon group and three or more unsaturated double bond groups is a compound represented by any of Formulae A-1, A-2, A-3, A-4, A′-1, A′-2, A′-3, A′-4, B-1, B-2, B-3, and B′-3.

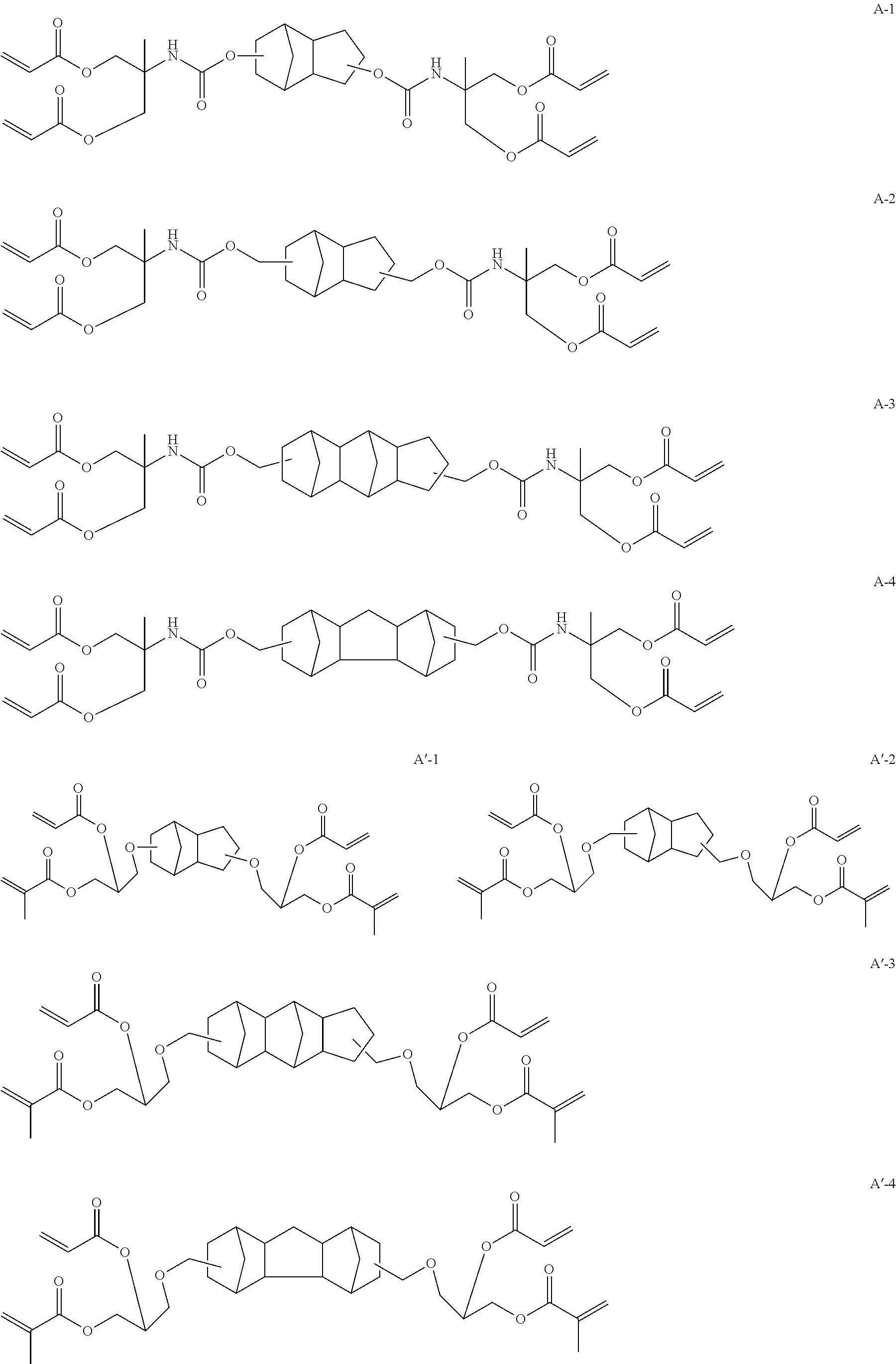

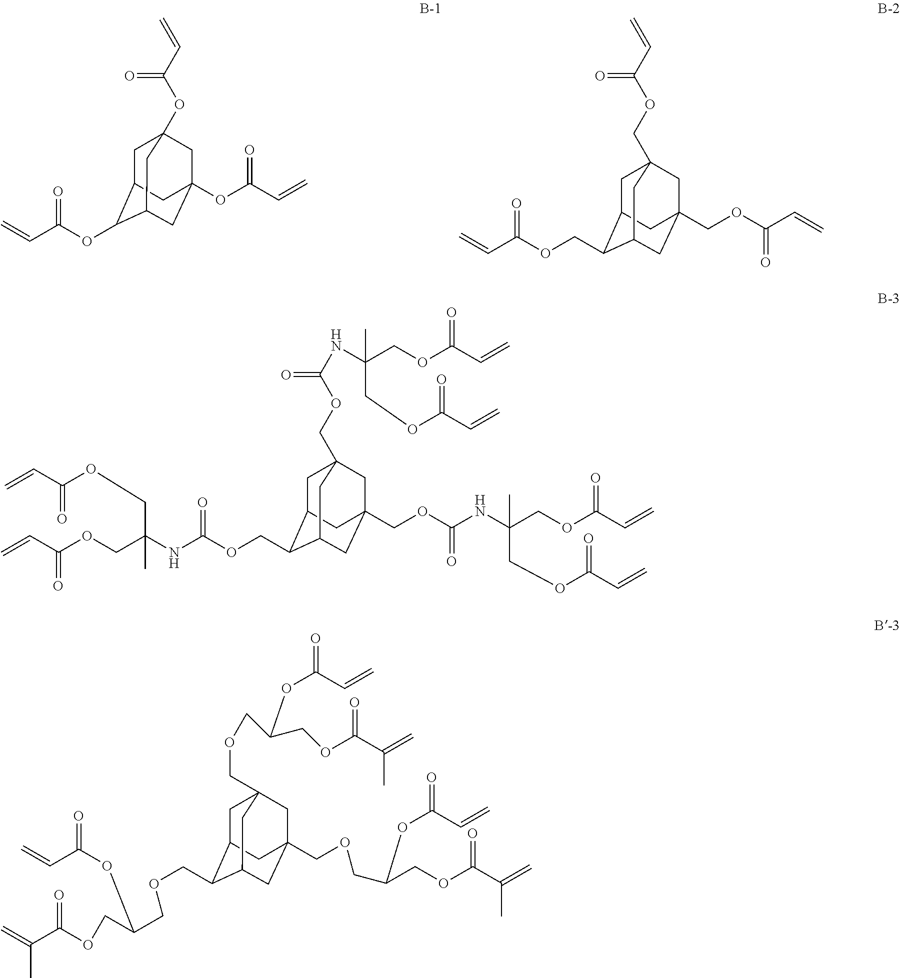

(4) The hardcoat film according to (1),

wherein the cyclic aliphatic hydrocarbon group is the group represented by Formula (I).

(5) The hardcoat film according to (1),

wherein a content of the compound having a cyclic aliphatic hydrocarbon group and three or more unsaturated double bond groups is 60% by mass to 99% by mass based on a solid content except for inorganic components in the hardcoat layer-forming composition.

(6) The hardcoat film according to (1),

wherein the hardcoat layer-forming composition contains a (meth)acrylate compound having no cyclic aliphatic hydrocarbon group in an amount of 5% by mass to 20% by mass based on a solid content except for inorganic components in the hardcoat layer-forming composition.

(7) The hardcoat film according to (1),

wherein the transparent support is a thermoplastic resin film including a (meth)acrylic polymer as a main component.

(8) The hardcoat film according to (7),

wherein the (meth)acrylic polymer is a polymer having at least one selected from the group consisting of a lactone ring structure, an anhydrous glutaric acid ring structure and a glutarimide ring structure, in a main chain of the polymer.

(9) The hardcoat film according to (7),

wherein the (meth)acrylic polymer is a polymer having a unit represented by Formula (A):

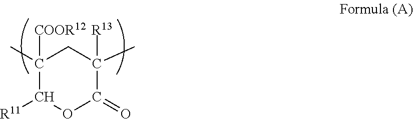

wherein in Formula (A), each of R¹¹, R¹², and R¹³ independently represents a hydrogen atom or an organic residue having 1 to 20 carbon atoms, and the organic residue may contain an oxygen atom.

(10) The hardcoat film according to (1),

wherein the transparent support is a cellulose acylate film.

(11) A method for fabricating the hardcoat film according to (1), the method including:

forming a hardcoat layer with a hardcoat layer-forming composition containing a compound having a cyclic aliphatic hydrocarbon group and three or more ethylenically unsaturated double bond groups in a molecule of the compound, and a polymerization initiator on at least one surface-side of a transparent support.

(12) An antireflection film including:

the hardcoat film according to (1); and

a low refractive index layer with lower refractive index than the transparent support,

wherein the low refractive index is provided on a side of the hardcoat layer opposite to the transparent support.

(13) A polarizing plate including the hardcoat film according to (1).

(14) A polarizing plate including the antireflection film according to (12).

(15) An image display device including the hardcoat film according to (1).

(16) An image display device including the antireflection film according to (12).

(17) An image display device including the polarizing plate according to (13).

According to the present invention, it is possible to provide a hardcoat film having low moisture permeability, sufficient surface hardness and excellent productivity, and to provide a hardcoat film, which is suitable for making a polarizing plate or an image display device equipped with the same thinner, because there is no problem of warpage caused by a change in the environment of the mounted image display device.

### DETAILED DESCRIPTION OF INVENTION

Hereinafter, embodiments for carrying out the present invention will be described in detail, but the present invention is not limited thereto. Further, in the present specification, when numerical values represent physical property values, characteristic values and the like, the description “(numerical value 1) to (numerical value 2)” represents the meaning of “(numerical value 1) or more and (numerical value 2) or less”.

The present invention relates to a hardcoat film having a hardcoat layer on at least one surface of a transparent support, in which the hardcoat film is formed from a hardcoat layer-forming composition including a compound having a cyclic aliphatic hydrocarbon group and three or more ethylenically unsaturated double bond groups in a molecule thereof, and a polymerization initiator.

Hereinafter, materials used in a hardcoat film, an antireflection film, a polarizing plate, and an image display device of the present invention and a method for fabricating the same will be described in detail.

The hardcoat film of the present invention has low moisture permeability and sufficient surface hardness. The specific value thereof is preferably 120 g/m² per day or less, more preferably 100 g/m² per day or less, and particularly preferably 95 g/m² per day or less when the moisture permeability is measured at 40° C. and 90% RH by the method described in Examples.

The sufficient surface hardness means that the pencil hardness is high. A specific preferred range of the pencil hardness will be described in the explanation of the hardcoat layer to be described below.

[Transparent Support]

[Material of Transparent Support]

As the material for forming the transparent support of the present invention, preferred is a polymer having excellent optical transparency, mechanical strength, thermal stability, isotropy, and the like. The term “transparent” as used herein means that transmittance of visible light is 60% or more, preferably 80% or more, and particularly preferably 90% or more. Examples of the polymer may include polycarbonate-based polymers, polyester-based polymers such as polyethylene terephthalate or polyethylene naphthalate, (meth)acrylic polymers such as polymethyl methacrylate, and styrenic polymers such as polystyrene or acrylonitrile-styrene copolymer (AS resin). Further, examples thereof may also include polyolefin such as polyethylene and polypropylene, polyolefinic polymers such as ethylene-propylene copolymer, vinyl chloride-based polymers, amide-based polymers such as nylon or aromatic polyamide, imide-based polymers, sulfone-based polymers, polyether sulfone-based polymers, polyether ether ketone-based polymers, polyphenylene sulfide-based polymers, vinylidene chloride-based polymers, vinylbutyral-based polymers, arylate-based polymers, polyoxymethylene-based polymer, epoxy-based polymer, or a mixture of the polymers. In addition, the polymer film of the present invention may also be formed as a cured layer of an ultraviolet ray-setting type or a thermosetting type resin, such as an acrylic resin, a urethane-based resin, an acrylic urethane-based resin, an epoxy-based resin, and a silicone-based resin.

As a material for forming the transparent support of the present invention, it is possible to preferably use a cellulose-based polymer (particularly preferably cellulose acylate) represented by triacetyl cellulose which has been used as a transparent protective film of a polarizing plate in the related art. Further, it is possible to preferably use the material even in an acrylic film of which the introduction has been recently suggested as a protective film of a polarizing plate. Hereinafter, as an example of the transparent support of the present invention, cellulose acylate and (meth)acrylic polymers will be mainly described in detail, but the technical matters thereof may be applied likewise to other polymer films

[Cellulose Acylate Substitution Degree]

Subsequently, the above-described cellulose acylate of the present invention prepared using cellulose as a raw material will be described. The cellulose acylate is prepared through acylation of a hydroxyl group in cellulose, and as the substituent thereof, it is possible to use an acyl group having 2 to 22 carbon atoms. In the cellulose acylate of the present invention, the substitution degree of hydroxyl groups of cellulose is not particularly limited, but the substitution degree may be obtained through calculation by measuring the bonding degree of acetic acid and/or a fatty acid having 3 to 22 carbon atoms which are substituted with the hydroxyl groups in cellulose. The measurement method may be carried out in accordance with D-817-91 of ASTM.

In the cellulose acylate, the substitution degree of hydroxyl groups of cellulose is not particularly limited, but the acyl substitution degree of hydroxyl groups of cellulose is preferably 2.50 to 3.00. Further, the substitution degree is preferably 2.75 to 3.00 and more preferably 2.85 to 3.00.

Of acetic acid and/or the fatty acid having 3 to 22 carbon atoms substituted with the hydroxyl group in cellulose, an acyl group having 2 to 22 carbon atoms may be an aliphatic group or an aromatic group and is not particularly limited, and the acyl group may be either a single group or a mixture of two or more thereof. Examples of the cellulose ester acylated by these groups may include alkylcarbonyl ester of cellulose and alkenylcarbonyl ester of cellulose, aromatic carbonyl ester of cellulose, aromatic alkyl carbonyl ester of cellulose, and the like, each of which may have a group further substituted. Preferred examples of the acyl group may include an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexanecarbonyl group, an oleoyl group, a benzoyl group, a naphthylcarbonyl group, a cinnamoyl group, and the like. Among them, the acyl group is preferably an acetyl group, a propionyl group, a butanoyl group, a dodecanoyl group, an octadecanoyl group, a t-butanoyl group, an oleoyl group, a benzoyl group, a naphthylcarbonyl group, a cinnamoyl group or the like, and more preferably an acetyl group, a propionyl group or a butanoyl group are more preferred.

<Cellulose Acylate-Based Transparent Support>

[Polymerization Degree of Cellulose Acylate]

The polymerization degree of cellulose acylate preferably used in the present invention is 180 to 700 as the viscosity average polymerization degree, and the polymerization degree of cellulose acetate is more preferably 180 to 550, still more preferably 180 to 400, and particularly preferably 180 to 350.

<(Meth)acrylic Polymer-Based Transparent Support>

As a (meth)acrylic polymer-based transparent support, preferred is a transparent support including a (meth)acrylic polymer as a main component. Further, the fact that a transparent support includes a (meth)acrylic polymer as a main component in the present application means that the transparent support contains the (meth)acrylic polymer in an amount of 50% by weight or more.

Further, the (meth)acrylic polymer is a concept that includes both methacrylic polymers and acrylic polymers. Further, the (meth)acrylic polymer includes derivatives of acrylate/methacrylate, particularly (co)polymers of acrylate ester/methacrylate ester.

((Meth)acrylic Polymer)

The repeating structural unit of the (meth)acrylic polymer is not particularly limited. It is preferred that the (meth)acrylic polymer has a repeating structural unit derived from a (meth)acrylic acid ester monomer as a repeating structural unit.

As the repeating structural unit, the (meth)acrylic polymer may include a repeating structural unit constructed by polymerizing at least one selected from monomers represented by the following Formula (201).

CH₂═C(X)R²⁰¹ Formula (201)

(In the formula, R²⁰¹ represents a hydrogen atom or a methyl group, X represents a hydrogen atom, an alkyl group having 1 to 20 carbon atoms, an aryl group, a —CN group, a —CO—R²⁰² group or a —O—CO—R²⁰³ group, and R²⁰² and R²⁰³ represent an organic residue having 1 to 20 carbon atoms.)

The (meth)acrylic acid ester is not particularly limited, but examples thereof include: acrylic acid ester such as methyl acrylate, ethyl acrylate, n-butyl acrylate, isobutyl acrylate, t-butyl acrylate, cyclohexyl acrylate, and benzyl acrylate; methacrylic acid ester such as methyl methacrylate, ethyl methacrylate, propyl methacrylate, n-butyl methacrylate, isobutyl methacrylate, t-butyl methacrylate, cyclohexyl methacrylate, and benzyl methacrylate; and the like, and these may be used either alone or in combination of two or more thereof. Among them, methyl methacrylate is particularly preferred from the viewpoint of excellent heat resistance and transparency.

When the (meth)acrylic acid ester is used, the content ratio thereof in the monomer component used in the polymerization process is preferably 10% by weight to 100% by weight, more preferably 30% by weight to 100% by weight, still more preferably 40% by weight to 100% by weight, and particularly preferably 50% by weight to 100% by weight, in order to sufficiently exhibit the effect of the present invention.

Examples of the monomer represented by Formula (201) may include styrene, vinyl toluene, α-methyl styrene, acrylonitrile, methylvinyl ketone, ethylene, propylene, vinyl acetate and the like, and these may be used either alone or in combination of two or more thereof. Among them, styrene and α-methyl styrene are preferred from the viewpoint of sufficiently exhibiting the effect of the present invention.

When the monomer represented by Formula (201) is used, the content ratio thereof in the monomer component used in the polymerization process is preferably 0% by weight to 30% by weight, more preferably 0% by weight to 20% by weight, still more preferably 0% by weight to 15% by weight, and particularly preferably 0% by weight to 10% by weight, in order to sufficiently exhibit the effect of the present invention.

[(Meth)acrylic Polymer having Ring Structure in Main Chain]

Among the (meth)acrylic polymers, preferred is a (meth)acrylic polymer having a ring structure in a main chain thereof. Heat resistance may be improved by introducing a ring structure into the main chain to increase rigidity of the main chain.

In the present invention, among the (meth)acrylic polymers having a ring structure in a main chain thereof, preferred is any of a polymer containing a lactone ring structure in a main chain thereof, a polymer having an anhydrous glutaric acid ring structure in a main chain thereof, and a polymer having a glutarimide ring structure in a main chain thereof. Among them, more preferred is the polymer containing a lactone ring structure in a main chain thereof.

Hereafter, these polymers having a ring structure in a main chain thereof will be sequentially described.

[(Meth)Acrylic Polymer Having Lactone Ring Structure in Main Chain]

The (meth)acrylic polymer having a lactone ring structure in a main chain thereof (hereinafter, also referred to as the lactone ring-containing polymer) is not particularly limited as long as the polymer is a (meth)acrylic polymer having a lactone ring in a main chain thereof, but preferably has a lactone ring structure represented by the following Formula (401).

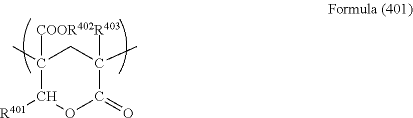

In Formula (401), each of R⁴⁰¹, R⁴⁰² and R⁴⁰³ independently represents a hydrogen atom or an organic residue having 1 to 20 carbon atoms, and the organic residue may contain an oxygen atom. Here, as the organic residue having 1 to 20 carbon atoms, preferred are a methyl group, an ethyl group, an isopropyl alcohol, an n-butyl group, a t-butyl group and the like.

The content ratio of the lactone ring structure represented by Formula (401) in the lactone ring-containing polymer structure is preferably 5% by mass to 90% by mass, more preferably 10% by mass to 70% by mass, still more preferably 10% by mass to 60% by mass, and particularly preferably 10% by mass to 50% by mass. The obtained polymer tends to have improved heat resistance and surface hardness by setting the content ratio of the lactone ring structure to 5% by mass or more, and the obtained polymer tends to have improved molding processability by setting the content ratio of the lactone ring structure to 90% by mass or less.

A preparation method of the lactone ring-containing polymer is not particularly limited, but preferably, the lactone ring-containing polymer is obtained by obtaining a polymer (p) having a hydroxyl group and an ester group in a molecular chain by a polymerization process, and then performing a lactone cyclization condensation process of introducing the lactone ring structure into the polymer by heat-treating the obtained polymer (p).

A mass average molecular weight of the lactone ring-containing polymer is preferably 1,000 to 2,000,000, more preferably 5,000 to 1,000,000, still more preferably 10,000 to 500,000, and particularly preferably 50,000 to 500,000.

A mass decrease ratio of the lactone ring-containing polymer in a range of 150° C. to 300° C. in dynamic TG measurement is preferably 1% or less, more preferably 0.5% or less, and still more preferably 0.3% or less. As for the dynamic TG measurement method, it is possible to use a method described in Japanese Patent Application Laid-Open No. 2002-138106.

Since the lactone ring-containing polymer has a high cyclization condensation reaction rate, dealcoholization reaction rarely occurs during a manufacturing process of molded articles, and thus it is possible to avoid a defect such as bubbles or silver streaks that enter into the molded articles after the molding which results from the alcohol. Further, since the lactone ring structure is sufficiently introduced into the polymer due to the high cyclization condensation reaction rate, the obtained lactone ring-containing polymer has high heat resistance.

When a chloroform solution containing the lactone ring-containing polymer in a concentration of 15% by mass is prepared, a coloring degree (YI) thereof is preferably 6 or less, more preferably 3 or less, still more preferably 2 or less, and particularly preferably 1 or less. When the coloring degree (YI) is 6 or less, the lactone ring-containing polymer may be preferably used because it is difficult for problems to occur in that transparency is damaged by colorization, and the like.

A 5% mass decreasing temperature of the lactone ring-containing polymer in the thermogravimetric analysis (TG) is preferably 330° C. or more, more preferably 350° C. or more, and still more preferably 360° C. or more. The 5% mass decreasing temperature in the thermogravimetric analysis (TG) is an index of thermal stability, and sufficient thermal stability tends to be easily exhibited by setting the temperature to 330° C. or more. In the thermogravimetric analysis, a dynamic TG measurement device may be used.

A glass transition temperature (Tg) of the lactone ring-containing polymer is preferably 115° C. or more, more preferably 125° C. or more, still more preferably 130° C. or more, particularly preferably 135° C. or more, and most preferably 140° C. or more.

A total amount of residual volatile components contained in the lactone ring-containing polymer is preferably 5,000 ppm or less, more preferably 2,000 ppm or less, still more preferably 1,500 ppm, and particularly preferably 1,000 ppm. When the total amount of residual volatile components is 5,000 ppm or less, it is difficult for molding defects, such as coloring, bubbling, or silver streaks caused by a change in properties during the molding thereof, to occur, which is preferred.

A total light transmittance of the lactone ring-containing polymer, which is measured on molded articles obtained by injection molding by the method in accordance with ASTM-D-1003, is preferably be 85% or more, more preferably 88% or more, and still more preferably 90% or more. The total light transmittance is an index of transparency, and when total light transmittance is 85% or more, the transparency tends to be improved.

In the case of a polymerization form using a solvent, a polymerization solvent is not particularly limited, but may include: aromatic hydrocarbon-based solvents such as toluene, xylene and ethylbenzene; ketone-based solvents such as methyl ethyl ketone and methyl isobutyl ketone; ether-based solvents such as tetrahydrofuran; and the like, and these may be used either alone or in combination of two or more thereof.

In a first embodiment of the preparation method of the present invention, since the polymer is formed by dissolving a (meth)acrylic resin in an organic solvent and performing a solution casting, the organic solvent during the synthesis of the (meth)acrylic resin is not limited even when a melt film formation is performed, and the polymer may be synthesized using an organic solvent having a high boiling point.

During the polymerization reaction, a polymerization initiator may be added, if necessary. The polymerization initiator is not particularly limited, but examples thereof may include: organic peroxides such as cumene hydroperoxide, diisopropylbenzene hydroperoxide, di-t-butyl peroxide, lauroyl peroxide, benzoyl peroxide, t-butylperoxyisopropyl carbonate and t-amylperoxy-2-ethylhexanoate; azo compounds such as 2,2′-azobis(isobutyronitrile), 1,1′-azobis(cyclohexanecarbonitrile) and 2,2′-azobis(2,4-dimethylvaleronitrile); and the like, and these may be used either alone or in combination of two or more thereof. An amount of the polymerization initiator used may be set properly according to a combination of monomers used or reaction conditions, and is not particularly limited.

It is possible to adjust a weight average molecular weight of the polymer by adjusting the amount of the polymerization initiator.

When polymerization is carried out, the concentration of the polymer produced in a polymerization reaction mixture is preferably controlled to be 50% by weight or less in order to suppress gelation of a reaction liquid. Specifically, when the concentration of the polymer produced in the polymerization reaction mixture exceeds 50% by weight, it is preferred that the polymerization solvent is properly added to the polymerization reaction mixture so that the concentration is controlled to be 50% by weight or less. The concentration of the polymer produced in the polymerization reaction mixture is more preferably 45% by weight or less, and still more preferably 40% by weight or less.

The embodiment of properly adding the polymerization solvent to the polymerization reaction mixture is not particularly limited, and the polymerization solvent may be added continuously or intermittently. By controlling the concentration of the polymer produced in the polymerization reaction mixture as described above, the gelation of the reaction liquid may be sufficiently suppressed. The polymerization solvent to be added may be the same solvent as that used at the time of the initial preparation for the polymerization reaction, and may be different kinds of solvents, but it is preferred to use the same solvent as that used at the time of the initial preparation for the polymerization reaction. Further, the polymerization solvent to be added may be a single solvent, and may be a mixture of two or more kinds of solvents.

(Polymer Having Anhydrous Glutaric Acid Ring Structure in Main Chain)

The polymer having an anhydrous glutaric acid ring structure in a main chain thereof indicates a polymer having a glutaric anhydride unit.

It is preferred that the polymer having a glutaric anhydride unit has a glutaric anhydride unit (hereinafter, referred to as the glutaric anhydride unit) represented by the following Formula (101).

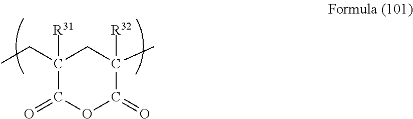

In Formula (101), each of R³¹ and R³² independently represents a hydrogen atom or an organic residue having 1 to 20 carbon atoms. Further, the organic residue may include an oxygen atom. R³¹ and R³² particularly preferably represent a hydrogen atom or an alkyl group having 1 to 5 carbon atoms, which is the same as or different from each other.

It is preferred that the polymer having a glutaric anhydride unit is a (meth)acrylic polymer containing a glutaric anhydride unit. It is preferred that the (meth)acrylic polymer has a glass transition temperature (Tg) of 120° C. or more from the viewpoint of heat resistance.

The content of the glutaric anhydride unit based on the (meth)acrylic polymer is preferably 5% by mass to 50% by mass, and more preferably 10% by mass to 45% by mass. By setting the content to 5% by mass or more, and more preferably 10% by mass, it is possible to obtain an effect of enhancing heat resistance, and furthermore, it is also possible to obtain an effect of enhancing weather resistance.

It is preferred that the aforementioned (meth)acrylic copolymer also includes a repeating unit based on an ethylenically unsaturated carboxylic acid alkyl ester. As the repeating unit based on an ethylenically unsaturated carboxylic acid alkyl ester, for example, a repeating unit represented by the following Formula (102) is preferred.

—[CH₂—C(R⁴¹)(COOR⁴²)]— Formula (102)

In Formula (102), R⁴¹ represents hydrogen or an alkyl group having 1 to 5 carbon atoms, and R⁴² represents an aliphatic or alicyclic hydrocarbon group having 1 to 6 carbon atoms, or an aliphatic or alicyclic hydrocarbon group having 1 to 6 carbon atoms substituted with one to the number of the carbon atoms of a hydroxyl group or a halogen atom.

A monomer corresponding to the repeating unit represented by Formula (102) is represented by the following Formula (103).

CH₂═C(R⁴¹)(COOR⁴²) Formula (103)

Preferred specific examples of the monomer may include methyl(meth)acrylate, ethyl(meth)acrylate, n-propyl(meth)acrylate, n-butyl(meth)acrylate, t-butyl(meth)acrylate, n-hexyl(meth)acrylate, cyclohexyl(meth)acrylate, chloromethyl(meth)acrylate, 2-chloroethyl(meth)acrylate, 2-hydroxyethyl(meth)acrylate, 3-hydroxypropyl(meth)acrylate, 2,3,4,5,6-pentahydroxyhexyl(meth)acrylate, 2,3,4,5-tetrahydroxypentyl(meth)acrylate, and the like, and among them, methyl methacrylate is most preferably used. These monomers may be either alone or in combination of two or more thereof.

The content of the aforementioned ethylenically unsaturated carboxylic acid alkyl ester unit based on the (meth)acrylic polymer is preferably 50% by mass to 95% by mass, and more preferably 55% by mass to 90% by mass. The (meth)acrylic polymer having a gluaric anhydride unit and an ethylenically unsaturated carboxylic acid alkyl ester-based unit may be obtained, for example, by the cyclizing polymerization of a copolymer having an ethylenically unsaturated carboxylic acid alkyl eater-based unit and an ethylenically unsaturated carboxylic acid unit.

It is preferred that the ethylenically unsaturated carboxylic acid unit is represented, for example, by the following Formula (104).

—[CH₂—C(R⁵¹)(COOH)]— Formula (104)

Here, R⁵¹ represents hydrogen or an alkyl group having 1 to 5 carbon atoms. Specific preferred examples of the monomer from which the ethylenically unsaturated carboxylic acid unit is derived may include a compound represented by the following Formula (105), which is a monomer corresponding to the repeating unit represented by Formula (104), a maleic acid, and furthermore, a hydrolysate of maleic anhydride, and the like. However, from the viewpoint of excellent thermal stability, acrylic acid and methacrylic acid are preferred, and methacrylic acid is more preferred.

CH₂═C(R⁵¹)(COOH) Formula (105)

These monomers may be either alone or in combination of two or more thereof. As described above, the acrylic thermoplastic copolymer having a gluaric anhydride unit and an ethylenically unsaturated carboxylic acid alkyl ester-based unit may be obtained, for example, by the cyclizing polymerization of a copolymer having an ethylenically unsaturated carboxylic acid alkyl eater-based unit and an ethylenically unsaturated carboxylic acid unit.

The (meth)acrylic polymer may have other aromatic ring-free vinyl-based monomer units within a range not impairing the effects of the present invention. Specific examples of the other aromatic ring-free vinyl-based monomer unit may include, in terms of the corresponding monomer, a vinyl cyanide-based monomer such as acrylonitrile, methacrylonitrile, and ethacrylonitrile; allyl glycidyl ether; maleic anhydride and itaconic anhydride; N-methylmaleimide, N-ethylmaleimide, N-cyclohexylmaleimide, acrylamide, methacrylamide, N-methylacrylamide, butoxymethylacrylamide and N-propylmethacrylamide; aminoethyl acrylate, propylaminoethyl acrylate, dimethylaminoethyl methacrylate, ethylaminopropyl methacrylate and cyclohexylaminoethyl methacrylate; N-vinyldiethylamine, N-acetylvinylamine, allylamine, methallylamine and N-methylallylamine; and 2-isopropenyl-oxazoline, 2-vinyl-oxazoline, 2-acroyl-oxazoline, and the like. These monomer units may be either alone or in combination of two or more thereof.

The content of the aforementioned other aromatic ring-free vinyl-based monomer unit based on the (meth)acrylic polymer is preferably 35% by mass or less.

Further, since an aromatic ring-containing vinyl-based monomer unit (N-phenylmaleimide, phenylaminoethyl methacrylate, p-glycidylstyrene, p-aminostyrene, 2-styryl-oxazoline, and the like) tends to decrease scratch resistance and weather resistance, the content thereof based on the aforementioned (meth)acrylic polymer is preferably 1% by mass or less.

((Meth)Acrylic Polymer Having Glutarimide Ring Structure in Main Chain)

The (meth)acrylic polymer having a glutarimide ring structure in a main chain thereof (hereinafter, also referred to as the glutarimide-based resin) has a grluarimide ring structure in a main chain thereof so as to exhibit a preferred characteristic balance in terms of optical characteristics, heat resistance, or the like. It is preferred that the (meth)acrylic polymer having a glutarimide ring structure in a main chain thereof contains a glutarimide resin having 20% by weight or more of a glutarimide unit represented by the following Formula (301):

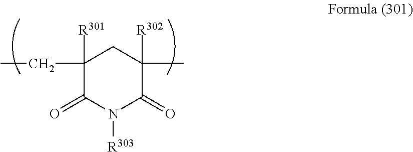

wherein in the formula, each of R³⁰¹, R³⁰² and R³⁰³ is independently hydrogen or an unsubstituted or substituted alkyl group, cycloalkyl group, and aryl group, which have 1 to 12 carbon atoms.

In the preferred glutarimide unit constituting the glutarimide-based resin used in the present invention, R³⁰¹ and R³⁰² are hydrogen or a methyl group, and R³⁰³ is a methyl group or a cyclohexyl group. The glutarimide unit may be a single type or may include a plurality of types in which R³⁰¹, R³⁰² and R³⁰³ are different.

A preferred second constitutional unit constituting the glutarimide-based resin used in the present invention is a unit including acrylic acid ester or methacrylic acid ester. Examples of the preferred acrylic acid ester or methacrylic acid ester constitutional unit may include methyl acrylate, ethyl acrylate, methyl methacrylate, methyl methacrylate and the like. Further, examples of other preferred imidizable units may include N-alkyl methacrylamide such as N-methyl methacrylamide or N-ethyl methacrylamide. These second constitutional units may be a single type or may include a plurality of types.

The content of the glutarimide unit represented by Formula (301) in the glutarimide-based resin is 20% by weight or more based on the total repeating unit of the glutarimide-based resin. The preferred content of the glutarimide unit is 20% by weight to 95% by weight, more preferably 50% by weight to 90% by weight, and still more preferably 60% by weight to 80% by weight. When the content of the glutarimide unit is less than the range, heat resistance of the film obtained is insufficient or transparency thereof is impaired in some cases. Further, when the content of the glutarimide unit exceeds the range, heat resistance is unnecessarily increased so that a film is difficult to be made, and further, mechanical strength of the film obtained is extremely vulnerable, and transparency thereof is impaired in some cases.

In the glutarimide-based resin, a third constitutional unit may be further copolymerized, if necessary. As an example of the preferred third constitutional unit, it is possible to use a constitutional unit obtained by copolymerizing a styrene-based monomer such as styrene, a substituted styrene or α-methylstyrene, an acrylic monomer such as butyl acrylate, a nitrile-based monomer such as acrylonitrile or methacrylonitrile, and a maleimide-based monomer such as maleimide, N-methylmaleimide, N-phenylmaleimide and N-cyclohexylmaleimide. These monomers may be directly copolymerized with the glutarimide unit and an imidizable unit in the glutarimide-based resin, and may be graft-polymerized with a rein having the glutarimide unit and an imidizable unit. When a third component is added thereto, the content ratio of the third component in the glutarimide-based resin is preferably 5 mol % to 30 mol % based on the total repeating unit in the glutarimide-based resin.

The glutarimide-based resin is described in U.S. Pat. Nos. 3,284,425 and 4,246,374, and Japanese Patent Application Laid-Open No. H2-153904, and the like, and may be obtained by using, as a resin having an imidizable unit, a resin obtained by using methacrylic acid methylester and the like as a main raw material, and imidizing the resin having an imidizable unit using ammonia or substituted amine. When the glutarimide-based resin is obtained, a unit constituted by acrylic acid or methacrylic acid or anhydride thereof as a reaction byproduct is introduced into the glutarimide-based resin in some cases. The presence of the constitutional unit, particularly, such an acid anhydride is not preferred, because it reduces total light transmittance or haze of the obtained film of the present invention. The content of acrylic acid or methacrylic acid is 0.5 millequivalent or less, preferably 0.3 millequivalent or less, and more preferably 0.1 millequivalent or less, per 1 g of resin. In addition, as seen in Japanese Patent Application Laid-Open No. H02-153904, it is also possible to obtain a glutarimide-based resin through imidization using a resin mainly including N-methylacrylamide and methacrylic acid methylester.

It is preferred that the glutarimide-based resin has a weight average molecular weight of 1×10⁴ to 5×10⁵.

<UV Absorbing Agent>

UV absorbing agents preferably used in the support film will be described. An optical film of the present invention including the support film is used in a polarizing plate or a member for liquid crystal display, and UV absorbing agents are preferably used from the viewpoint of preventing deterioration in the polarizing plate or the liquid crystal and the like. UV absorbing agents, which are low in absorption of visible light at a wavelength of 400 nm or more from the viewpoint of excellence in ability to absorb UV light at a wavelength of 370 nm or less and excellent liquid crystal display performance, are preferably used. UV absorbing agents may be used either alone or in combination of two or more thereof. Examples thereof may include UV absorbing agents described in Japanese Patent Application Laid-Open No. 2001-72782 or Japanese Patent Application National Publication No. 2002-543265. Specific examples of the UV absorbing agents may include, for example, oxybenzophenone-based compounds, benzotriazole-based compounds, salicylic acid ester-based compounds, benzophenone-based compounds, cyano acrylate-based compounds, nickel complex salt-based compounds, and the like.

Among them, 2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidemethyl)-5′-methylphenyl)benzotriazole, 2,2-methylenebis(4-(1,1,3,3-tetramethylbutyl)-6-(2H-benzotriazol-2-yl)phenol), 2-(2′-hydroxy-3′-tert-butyl-5′-methylphenyl)-5-chlorobenzotriazole, 2,4-dihydroxybenzophenone, 2,2′-dihydroxy-4-methoxybenzophenone, 2-hydroxy-4-methoxy-5-sulfobenzophenone, bis(2-methoxy-4-hydroxy-5-benzoylphenylmethane), (2,4-bis-(n-octylthio)-6-(4-hydroxy-3,5-di-tert-butylanilino)-1,3,5-triazine, 2-(2′-hydroxy-3′,5′-di-tert-butylphenyl)-5-chlorobenzotriazole, (2(2′-hydroxy-3′,5′-di-tert-amylphenyl)-5-chlorobenzotriazole, 2,6-di-tert-butyl-p-cresol, pentaerythrityl-tetrakis[3-(3,5-di-tert-butyl-4-hydroxyphenyl)propionate], triethyleneglycol-bis[3-(3-tert-butyl-5-methyl-4-hydroxyphenyl)propionate], 1,6-hexanediol-bis[3-(3,5-di-tert-butyl-4-hydroxyphenyl)propionate], 2,4-bis-(n-octylthio)-6-(4-hydroxy-3,5-di-tert-butylanilino)-1,3,5-triazine, 2,2-thio-diethylenebis[3-(3,5-di-tert-butyl-4-hydroxyphenyl)propionate], octadecyl-3-(3,5-di-tert-butyl-4-hydroxyphenyl)propionate, N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl)-isocianurate, and the like may be exemplified. Particularly preferred are (2,4-bis-(n-octylthio)-6-(4-hydroxi-3,5-di-tert-butylanilino)-1,3,5-triazine, 2-(2′-hydroxy-3′,5′-di-tert-butylphenyl)-5-chlorbenzotriazole, 2-(2′-hydroxy-3′,5′-di-tert-amylphenyl)-5-chlorbenzotriazole, 2,6-di-tert-butyl-p-cresol, pentaerythrityl-tetrakis[3-(3,5-di-tert-butyl-4-hydroxyphenyl)propionate], and triethyleneglycol-bis[3-(3-tert-butyl-5-methyl-4-hydroxyphenyl)propionate]. Further, it is possible to use the UV absorbing agent in combination with, for example, a hydrazine-based metal deactivator such as N,N-bis[3-(3,5-di-tert-butyl-4-hydroxyphenyl)propionyl]hydrazine or a phosphor-based processing stabilizer such as tris(2,4-di-tert-butylphenyl)phosphite.

The UV absorbing agent may also be introduced into a resin as a constitutional unit having UV absorbing ability. Examples thereof may include a benzotriazole derivative, a triazine derivative, or a benzophenone derivative into which a polymerizable group is introduced. The polymerizable group to be introduced may be selected suitably depending on the structural unit of the resin.

Specific examples of the monomer may include 2-(2′-hydroxy-5′-methacryloyloxy)ethylphenyl-2H-benzotriazole (trade name: RUVA-93, manufactured by Otsuka Chemical Co., Ltd.), 2-(2′-hydroxy-5′-methacryloyloxy)phenyl-2H-benzotriazole, and 2-(2′-hydroxy-3′-t-butyl-5′-methacryloyloxy)phenyl-2H-benzotriazole.

[Other Additives of Transparent Support]

It is possible to add various additives (for example, an optical anisotropy adjusting agent, a wavelength dispersion adjusting agent, fine particles, a plasticizer, a deterioration preventive agent, a peeling agent, and the like) as well as the UV absorbing agent to the transparent support in the present invention. Further, when the transparent support is a cellulose acylate film, the timing for adding the additives may be any time point in a process of preparing a dope (process of preparing a cellulose acylate solution), but it is possible to perform a process of preparing the dope by adding the additives in the final stage in the process of preparing a dope.

[Matting Agent Particles]

It is preferred that particles as a matting agent are added to the transparent support in the present invention. Examples of the particles may include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Among the particles, a particle containing silicon is preferred in that the turbidity is reduced, and silicon dioxide is particularly preferred. It is preferred that the silicon dioxide particle has a primary average particle diameter of 20 nm or less and an apparent specific gravity of 70 g/L or more. The particles having primary particles having an average diameter as small as 5 to 16 um may reduce the haze of the film, which is more preferred. The apparent specific gravity is preferably 90 g/L to 200 g/L and more preferably 100 g/L to 200 g/L. A larger apparent specific gravity is preferred because a liquid dispersion at a high concentration may be prepared such that the haze is low, and the aggregation may be suppressed.

These particles usually form secondary particles having an average particle diameter of 0.1 μm to 3.0 μm, and are present as an aggregate of the primary particles in a film and form a convex portion of 0.1 μm to 3.0 μm on the surface of the film. The secondary average particle diameter is preferably 0.2 μm to 1.5 μm, more preferably 0.4 μm to 1.2 μm, and most preferably 0.6 μm to 1.1 μm. Particles in a film are observed under a scanning electron microscope and the diameters of circles circumscribed with the particles are taken as the primary or secondary particle diameter. In addition, 200 particles are observed by changing the site and the average value thereof is defined as the average particle diameter. Further, the unevenness state on the surface of the film may be measured by a technique such as AFM.

As the silicon dioxide particle, it is possible to use a commercially available product such as, for example, AEROSIL R972, R972V, R974, R812, 200, 200V, 300, R202, OX50 and TT600 (all manufactured by NIPPON AEROSIL Co., Ltd.), and the like. The zirconium oxide particle is commercially available under the trade name of, for example, AEROSIL R976 and R811 (both manufactured by NIPPON AEROSIL Co., Ltd.), and these products may be used.

Among them, AEROSIL 200V and AEROSIL R972V are a silicon dioxide particle having a primary average particle diameter of 20 nm or less and an apparent specific gravity of 70 g/L or more, and are particularly preferred because the particles provide a high effect of reducing a frictional coefficient of an optical film while maintaining turbidity of the optical film at a low level.

[Hardcoat Layer]

A hardcoat layer in a hardcoat film of the present invention will be described.

The hardcoat layer in the present invention refers to a layer formed on the transparent support and thus having pencil hardness higher than that of the transparent support single body. Practically, the pencil hardness (JIS K5400) after the hardcoat layer is layered is preferably H or more, more preferably 2H or more, and most preferably 3H or more.

A film thickness of the hardcoat layer is preferably 0.4 μm to 35 μm, more preferably 1 μm to 30 μm, and most preferably 1.5 μm to 20 μm.

The hardcoat layer in the present invention may have a single layer or a plurality of layers. When the hardcoat layer has a plurality of layers, it is preferred that the sum of the film thicknesses of all the hardcoat layers is in the upper range.

The optical film of the present invention may have an internal haze of 1% or more in order to make the interference unevenness inconspicuous. It is preferred that a surface on the side where the hardcoat layer is formed is substantially smooth from the viewpoint of visibility.

[Hardcoat Layer-Forming Composition]

In the present invention, the hardcoat layer may be formed by being coated with a composition, which contains a compound, which has a cyclic aliphatic hydrocarbon group and has three or more ethylenically unsaturated double bond groups in a molecule thereof, in order to impart low moisture permeability and high surface hardness, and a polymerization initiator, and containing, if necessary, a light-transmitting particle, a fluorine-containing or silicone-based compound, and a solvent, directly or through another layer on a support, followed by drying and curing. Hereinafter, each component will be described.

[Compound Having Cyclic Aliphatic Hydrocarbon Group and Three or More Ethylenically Unsaturated Double Bond Groups in Molecule]

The hardcoat layer-forming composition of the present invention contains a compound having a cyclic aliphatic hydrocarbon group and three or more ethylenically unsaturated double bond groups in a molecule thereof. The compound having a cyclic aliphatic hydrocarbon group and three or more ethylenically unsaturated double bond groups in a molecule thereof serves as a binder. Further, the compound having a cyclic aliphatic hydrocarbon group and three or more ethylenically unsaturated double bond groups in a molecule thereof may serve as a curing agent, and may improve strength or scratch resistance of a coating film and impart low moisture permeability.

It is possible to realize low moisture permeability and high surface hardness using the compound. Details are not clear, but the performance is thought to be caused by the following mechanism. A hydrophobic cyclic aliphatic hydrocarbon group is introduced into the hardcoat layer by using the compound having a cyclic aliphatic hydrocarbon group in a molecule thereof, and thereby reducing moisture permeability. Thus, water molecules are prevented from being permeated from the outside to the hardcoat layer by making the hardcoat layer hydrophobic. In addition, crosslinking point density is increased by having three or more ethylenically unsaturated double bond groups in a molecule thereof, and thereby limiting a diffusion path of water molecules in the hardcoat layer. It is thought that an increase in the crosslinking point density also has an effect of relatively increasing the density of the cyclic aliphatic hydrocarbon group, and makes the inside of the hardcoat layer more hydrophobic and prevents water molecules from being adsorbed, thereby reducing moisture permeability.

The cyclic aliphatic hydrocarbon group is preferably a group derived from an alicyclic compound having 7 or more carbon atoms, more preferably a group derived from an alicyclic compound having 10 or more carbon atoms, and still more preferably a group derived from an alicyclic compound having 12 or more carbon atoms.

The cyclic aliphatic hydrocarbon group is particularly preferably a group derived from a polycyclic compound such as bicyclic and tricyclic compounds.

More preferably, examples thereof may include a central structure of a compound described in the claims of Japanese Patent Application Laid-Open No. 2006-215096, a central structure, a structure of an adamantane derivative, or the like of a compound described in Japanese Patent Application Laid-Open No. S2001-10999.

The cyclic aliphatic hydrocarbon group (including a linking group) is preferably a group represented by any one of the following Formulae (I) to (V), more preferably a group represented by the following Formula (I), (II) or (IV), and still more preferably a group represented by the following Formula (I).

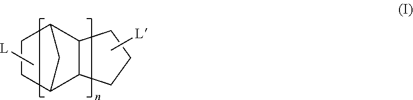

In Formula (I), each of L and L′ independently represents a di- or higher valent linking group, and both L and L′ are not divalent at the same time. n represents an integer of 1 to 3.

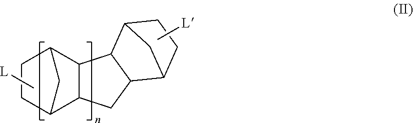

In Formula (II), each of L and L′ independently represents a di- or higher valent linking group, and both L and L′ are not divalent at the same time. n represents an integer of 1 to 2.

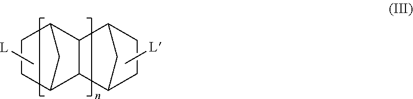

In Formula (III), each of L and L′ independently represents a di- or higher valent linking group, and both L and L′ are not divalent at the same time. n represents an integer of 1 to 2.

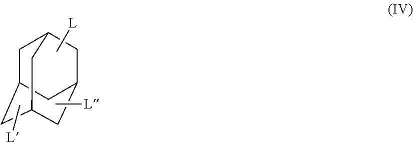

In Formula (IV), each of L, L′ and L″ independently represents a di- or higher valent linking group.

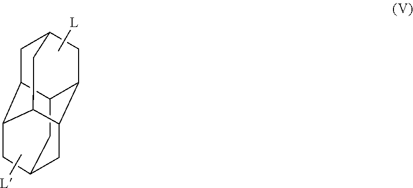

In Formula (V), each of L and L′ independently represents a di- or higher valent linking group, and both L and L′ are not divalent at the same time.

Specific examples of the cyclic aliphatic hydrocarbon group may include norbornyl, tricyclodecanyl, tetracyclodecanyl, pentacyclopentadecanyl, adamantly, diamantanyl, and the like.

Examples of the group having the ethylenically unsaturated double bond may include polymerizable functional groups such as a (meth)acryloyl group, a vinyl group, a styryl group, and an allyl group, and among them, the unsaturated double bond group is preferably a (meth)acryloyl group or —C(O)OCH═CH₂. Particularly preferably, it is possible to use the following compounds containing three or more (meth)acryloyl groups in a molecule thereof.

The compound having a cyclic aliphatic hydrocarbon group and three or more ethylenically unsaturated double bond groups in a molecule thereof is constituted by bonding the cyclic aliphatic hydrocarbon group and the group having an ethylenically unsaturated double bond through a linking group.

Examples of the linking group may include a single bond, an alkylene group having 1 to 6 carbon atoms, which may be substituted, an amide group which may be substituted at the N-position, a carbamoyl group which may be substituted at the N-position, an ester group, an oxycarbonyl group, an ether group, and a group obtained by combining these compounds.

These compounds may be easily synthesized by a one-step or two-step reaction of, for example, a polyol, such as diol and triol, having the cyclic aliphatic hydrocarbon group with carboxylic acid of a compound having a (meth)acryloyl group, a vinyl group, a styryl group, an allyl group or the like, a carboxylic acid derivative, an epoxy derivative, an isocyanate derivative, and the like.

Preferably, the compounds may be synthesized by reaction with a polyol having the cyclic aliphatic hydrocarbon group using a compound such as (meth)acrylic acid, (meth)acryloylchloride, (meth)acrylic anhydride and (meth)glycidyl acrylate, or a compound described in WO2012/00316A (for example, 1,1-bis(acryloxymethyl)ethyl isocyanate).

The compound having a cyclic aliphatic hydrocarbon group and three or more ethylenically unsaturated double bond groups in a molecule thereof is preferably a compound represented by any one of the following Formulae. In the following Formulae, the linking group and the group having the ethylenically unsaturated double bond are the same as those described above.

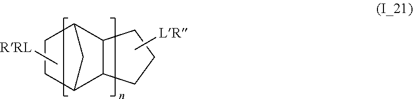

In Formula (I_{—}21), L represents a trivalent linking group, L′ represents a divalent linking group, and each of R, R′ and R″ independently represents the ethylenically unsaturated double bond group. n represents an integer of 1 to 3.

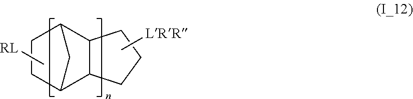

In Formula (I_{—}12), L represents a divalent linking group, L′ represents a trivalent linking group, and each of R, R′ and R″ independently represents the ethylenically unsaturated double bond group. n represents an integer of 1 to 3.

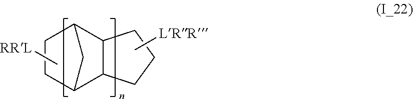

In Formula (I_{—}22), each of L and L′ independently represents a trivalent linking group, and each of R, R′, R″ and R′″ independently represents the ethylenically unsaturated double bond group. n represents an integer of 1 to 3.

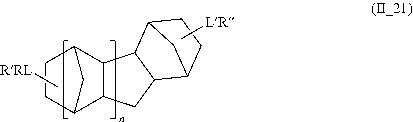

In Formula (II_{—}21), L represents a trivalent linking group, L′ represents a divalent linking group, and each of R, R′ and R″ independently represents the group having unsaturated double bond. n represents an integer of 1 to 2.

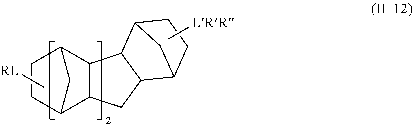

In Formula (II_{—}12), L represents a trivalent linking group, L′ represents a divalent linking group, and each of R, R′ and R″ independently represents the ethylenically unsaturated double bond group.

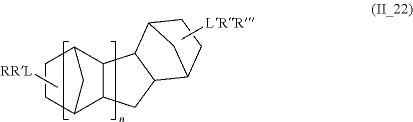

In Formula (II_{—}22), each of L and L′ independently represents a trivalent linking group, and each of R, R′, R″ and R′″ independently represents the ethylenically unsaturated double bond group. n represents an integer of 1 to 2.

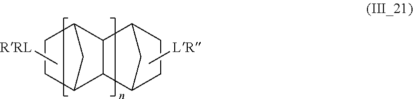

In Formula (III_{—}21), L represents a trivalent linking group, L′ represents a divalent linking group, and each of R, R′ and R″ independently represents the ethylenically unsaturated double bond group. n represents an integer of 1 to 2.

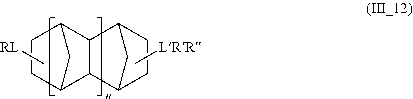

In Formula (III_{—}12), L represents a divalent linking group, L′ represents a trivalent linking group, and each of R, R′ and R″ independently represents the ethylenically unsaturated double bond group. n represents an integer of 1 to 2.

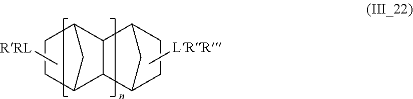

In Formula (III_{—}22), each of L and L′ independently represents a trivalent linking group, and each of R, R′, R″ and R′″ independently represents the ethylenically unsaturated double bond group. n represents an integer of 1 to 2.

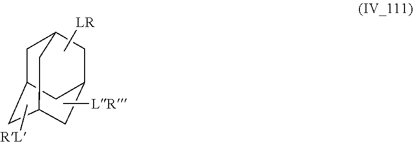

In Formula (IV_{—}111), each of L, L′ and L″ independently represents a divalent linking group, and each of R, R′ and R″ independently represents the ethylenically unsaturated double bond group.

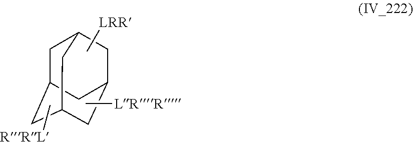

In Formula (IV_{—}222), each of L, L′ and L″ independently represents a trivalent linking group, and each of R, R′, R″, R′″, R″″ and R′″″ independently represents the ethylenically unsaturated double bond group.

Preferred specific example compounds of the compound having a cyclic aliphatic hydrocarbon group and three or more the ethylenically unsaturated double bond groups in a molecule thereof will be described below.

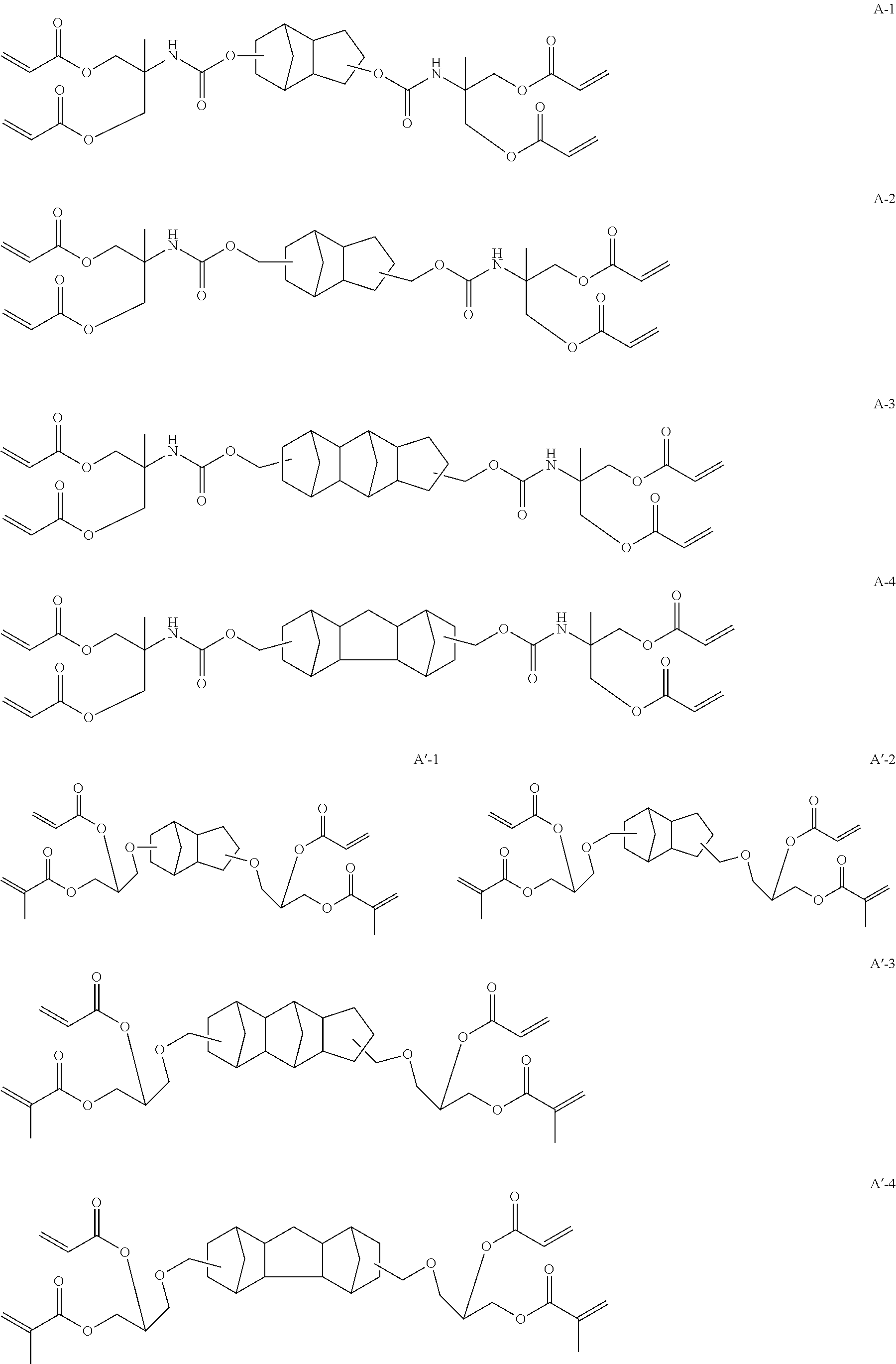

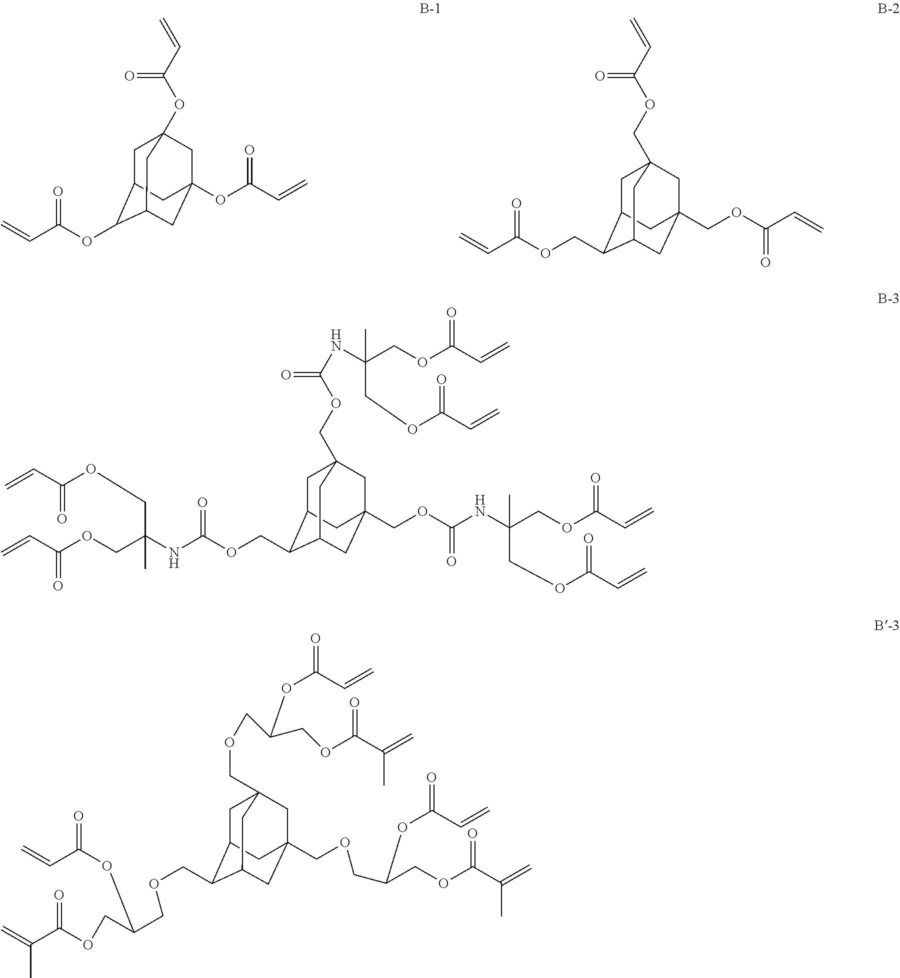

[Compound Having Ethylenically Unsaturated Double Bond Group Having No Cyclic Aliphatic Hydrocarbon Group]

Among the hardcoat layer-forming compositions used in the present invention, it is possible to use a compound having an ethylenically unsaturated double bond group having no cyclic aliphatic hydrocarbon group in a molecule thereof in combination within a range not impairing the effects of the present invention.

The compound having an ethylenically unsaturated double bond group having no cyclic aliphatic hydrocarbon group is preferably a (meth)acrylate compound having no cyclic aliphatic hydrocarbon group, and examples thereof may include (meth)acrylic acid diesters of an alkylene glycol, (meth)acrylic acid diesters of a polyoxyalkylene glycol, (meth)acrylic acid diesters of a polyhydric alcohol, (meth)acrylic acid diesters of an ethylene oxide or propylene oxide adduct, epoxy(meth)acrylates, urethane (meth)acrylates, polyester (meth)acrylates and the like.

Among them, esters of a polyhydric alcohol with a (meth)acrylic acid are preferred. Examples thereof may include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, polyurethane polyacrylate, polyester polyacrylate, caprolactone-modified tris(acryloxyethyl)isocyanurate and the like.

As the polyfunctional acrylate-based compounds having a (meth)acryloyl group, commercially available products may be used, and examples thereof may include NK ESTER A-TMMT manufactured by Shin-Nakamura Chemical Co., Ltd., KAYARAD DPHA manufactured by Nippon Kayaku Co., Ltd., and the like. Polyfunctional monomers are described in Paragraphs [0114] to [0122] of Japanese Patent Application Laid-Open No. 2009-98658, and the same applies to the present invention.

It is preferred that the compound having an ethylenically unsaturated double bond group having no cyclic aliphatic hydrocarbon group is a compound having a hydrogen-bonding substituent in terms of adhesion to a support, low curl, and fixation of a fluorine-containing or silicon-based compound to be described below. The hydrogen-bonding substituent refers to a substituent in which an atom having high electronegativity such as nitrogen, oxygen, sulfur and halogen is covalently bonded with a hydrogen bond, specific examples thereof include OH—, SH—, —NH—, CHO—, CHN—, and the like, and urethane (meth)acrylates and (meth)acrylates having a hydroxyl group are preferred. It is possible to use a commercially available polyfunctional acrylate having a (meth)acryloyl group, and examples thereof include NK oligo U4HA and NK ester A-TMM-3, both manufactured by Shin-Nakamura Chemical Co., Ltd., KAYARAD PET-30 manufactured by Nippon Kayaku Co., Ltd., and the like.

[Inorganic Particles]

Inorganic particles having an average particle diameter of 1 nm to 100 nm may be added to a coating composition of the present invention. Since curing shrinkage of the cured layer may be reduced by adding the particles thereto, adhesion to a support is improved. Further, when the support is a plastic film and the like, it is preferred that the production of curls may be reduced. As the particles, it is possible to use any of inorganic particles, organic particles, and organic-inorganic composite particles. Examples of the inorganic particles may include silicon oxide particles, titanium oxide particles, zirconium oxide particles, aluminum oxide particles, and the like. These inorganic particles are generally hard, and it is possible to lessen shrinkage during curing, and increase hardness of a surface by filling the hardcoat layer with the inorganic particles. However, since the particles generally tend to increase haze, a filling method is adjusted on the balance of each required characteristic.

In general, since inorganic particles have low affinity for organic components such as polyfunctional vinyl monomers, an aggregate is formed or a cured layer after curing is easily cracked by only mixing in some cases. In the present invention, in order to improve affinity of inorganic particles for organic components, the surface of organic particles may be treated with a surface modifying agent including an organic segment. It is preferred to have a surface modifying agent, a functional group that may form a bond with inorganic particles or be adsorbed to inorganic particles, and a functional group having high affinity for organic components in the same molecule. As a surface modifying agent having a functional group that may be bonded to or absorbed to inorganic particles, preferred is a metal alkoxide surface modifying agent such as silane, aluminum, titanium, and zirconium, or a surface modifying agent having an anionic group such as a phosphate group, a sulfate group, a sulfonate group and a carboxylate group. Further, as a functional group having high affinity for organic components, a functional group that has just the same hydrophilicity/hydrophobicity for organic components may be used, but a functional group which may be chemically bonded to organic components is preferred, and an ethylenically unsaturated double bond group or a ring-opening polymerizable group is particularly preferred. A preferred inorganic particle surface modifying agent in the present invention is a curable resin having metal alkoxide or an anionic group and an ethylenically unsaturated double bond group or a ring-opening polymerizable group in the same molecule.

Representative examples of the surface modifying agents may include an ethylenically unsaturated double bond-containing coupling agent, a phosphate group-containing organic curable resin, a sulfate group-containing organic curable resin, a carboxylate group-containing organic curable resin, and the like, as described below.

H₂C═C(X)COOC₃H₆Si(OCH₃)₃ S-1

H₂C═C(X)COOC₂H₄OTi(OC₂H₅)₃ S-2

H₂C═C(X)COOC₂H₄OCOC₅H₁₀OPO(OH)₂ S-3

(H₂C═C(X)COOC₂H₄OCOC₅H₁₀O)₂POOH S-4

H₂C═C(X)COOC₂H₄OSO₃H S-5

H₂C═C(X)COO(C₅H10COO)₂H S-6

H₂C═C(X)COOC₅H₁₀COOH S-7

CH₂CH(O)CH₂OC₃H₆Si(OCH₃)₃ S-8

(X represents a hydrogen atom or CH₃)

It is preferred that the surface modification of the inorganic particles is carried out in a solution. It is also possible to use a method of allowing the inorganic particles to be present with the surface modifying agent when the inorganic particles are mechanically dispersed finely, or adding and stirring the surface modifying agent after finely dispersing the inorganic particles, or conducting surface modification before finely dispersing the inorganic particles (conducting warming, heating after drying or pH change, if necessary), and then conducting fine dispersion. As a solution for dissolving the surface modifying agent, an organic solvent having high polarity is preferred. Specific examples thereof may include known solvents such as alcohol, ketone, and ester.

The organic particles are not particularly limited, but polymer particles obtained by polymerizing monomers having an ethylenically unsaturated group, for example, polymethyl methacrylate, polyethyl methacrylate, polyethyl acrylate, polybutyl acrylate, polyethylene, polypropylene, and polystyrene, and polymer particles composed of a polymer represented by Formulae (I) and (II) in the present invention are used preferably. In addition, examples thereof include resin particles such as polysiloxane, melamine resin, benzoguanamine resin, polytetrafluoroethylene, polycarbonate, nylon, polyvinyl alcohol, polyethylene terephthalate, polyvinyl chloride, acetyl cellulose, nitrocellulose and gelatin. It is preferred that these particles are crosslinked. As a pulverizing dispersion machines for the particles, it is preferred to use an ultrasonic disperser, a disperser, a homogenizer, a dissolver, a polytron, a paint shaker, a sand grinder, a kneader, an eiger mill, a DYNO mill, a co-bol mill, a high-pressure homogenizer, FILMIX and the like. Further, as a dispersing medium, the above-described solvent for surface modification is preferably used.

An amount of the particles to be filled is preferably 2% by mass to 60% by mass, more preferably 3% by mass to 50% by mass, and most preferably 5% by mass to 40% by mass, based on the volume of the cured layer after filling.

The content of the organic compound having an ethylenically unsaturated double bond group in the hardcoat layer-forming composition of the present invention is preferably 60% by mass to 99% by mass, more preferably 70% by mass to 99% by mass, and particularly preferably 80% by mass to 99% by mass, based on the total solid content except for inorganic components in the hardcoat layer-forming composition, in order to impart sufficient surface hardness.

The content of the compound having a cyclic aliphatic hydrocarbon group and three or more ethylenically unsaturated double bond groups in a molecule thereof is preferably from 60 to 99% by mass, more preferably from 70 to 99% by mass, and particularly preferably from 80 to 99% by mass, based on the total solid content except for inorganic components in the hardcoat layer-forming composition, in order to simultaneously impart sufficient low moisture permeability and high surface hardness.

The compound having an ethylenically unsaturated double bond group having no cyclic aliphatic hydrocarbon group (preferably, a (meth)acrylate compound having no cyclic aliphatic hydrocarbon group) is present in an amount of preferably 5% by mass to 20% by mass, more preferably 6% by mass to 18% by mass, and particularly preferably 7% by mass to 15% by mass, based on the total solid content except for inorganic components in the hardcoat layer-forming composition from the viewpoint of compatibility of moisture permeability and adhesion to a support.

[Light-Transmitting Particle]

The hardcoat film of the present invention may impart 1% or more internal haze, and may contain a hardcoat layer binder and light-scattering particles having a refractive index difference in the hardcoat layer.

Examples of the light-transmitting particles which may be used in the hardcoat layer may include polymethylmethacrylate particles (refractive index 1.49), crosslinked poly(acryl-styrene) copolymer particles (refractive index 1.54), melamine resin particles (refractive index 1.57), polycarbonate particles (refractive index 1.57), polystyrene particles (refractive index 1.60), crosslinked polystyrene particles (refractive index 1.61), polyvinyl chloride particles (refractive index 1.60), benzoguanamine-melamine formaldehyde particles (refractive index: 1.68), silica particles (refractive index 1.46), alumina particles (refractive index 1.63), zirconia particles, titania particles, particles having hollows or pores, or the like.

Among them, crosslinked poly((meth)acrylate) particles and crosslinked poly(acryl-styrene) particles are preferably used. By controlling the refractive index of the binder to suit the refractive index of each of light-transmitting particles chosen from these particles, it is also possible to impart surface unevenness, surface haze, internal haze, and total haze, which are suitable for the hardcoat layer.

The refractive index of the binder (light-transmitting resin) is preferably 1.45 to 1.70, and more preferably 1.48 to 1.65.

A difference of refractive index between the light-transmitting particles and the binder of the hardcoat layer (“refractive index of light-transmitting particles”−“refractive index of the hardcoat layer except for the light-transmitting particles”) is an absolute value, and preferably less than 0.05, more preferably 0.001 to 0.030, and still more preferably 0.001 to 0.020. When the difference of refractive index between the light-transmitting particles and the binder in the hardcoat layer is set to less than 0.05, a refraction angle of light is decreased by light-transmitting particles such that scattered light is not widened to a wide angle, and thus aggravating effects are not observed, such as depolarization of transmitted light of an optically anisotropic layer and the like, which is preferred.

The average particle diameter of the light-transmitting particles is preferably 0.5 μm to 12 μm, more preferably 1.0 μm to 10 μm, still more preferably 1.0 μm to 8 μm, and most preferably 1.0 μm to 6 μm. By setting the refractive index difference and the particle size to the range, a scattering angle distribution of light is not widened to a wide angle, and thus character blurring of a display and deterioration in contrast are not easily caused. The average particle diameter is preferably 12 μm or less in that a film thickness of a layer to be added needs not be large and it is difficult for problems such as curls or an increase in costs to occur. Further, it is preferred that the average particle diameter is set to the range even in that the coating amount during the coating may be suppressed, drying is rapidly achieved, and it is also difficult to cause planar defects such as drying unevenness.

Any measurement method may be applied to a method of measuring an average particle diameter of the light-transmitting particles as long as the method is a method of measuring an average particle diameter of particles, and preferably, particles are observed through a transmission electron microscope (magnification from 500,000 to 2,000,000 times) to observe 100 particles, and the average value thereof may be defined as an average particle diameter.

It is preferred that the light-transmitting particles are blended to be contained in an amount of 0.1% by mass to 40% by mass based on the total solid content in the hardcoat layer. The amount is more preferably 1% by mass to 30% by mass, and still more preferably 1% by mass to 20% by mass.

The coating amount of the light-transmitting particles is preferably 10 mg/m² to 2,500 mg/m², more preferably 30 mg/m² to 2,000 mg/m², and still more preferably 100 mg/m² to 1,500 mg/m².

<Preparation of Light-Transmitting Particles, Classification Method>

Examples of the preparation method of the light-transmitting particles may include a suspension polymerization method, an emulsion polymerization method, a soap-free emulsion polymerization method, a dispersion polymerization method, a seed polymerization method, and the like, and the light-transmitting particles may be prepared by any method. These preparation methods may be carried out with reference to the methods described in, for example, “Experimental Methods of Polymer Synthesis” (co-authored by Takayuki Otsu and Masayoshi Kinoshita and published by Kagaku-Dojin Publishing Co., Inc.), pages 130, 146, and 147, “Synthetic Polymers” Vol. 1, pages 246 to 290, ibid., Vol. 3, pages 1 to 108, the specifications of Japanese Patent Nos. 2543503, 3508304, 2746275, 3521560, and 3580320, Japanese Patent Application Laid-Open Nos. H10-1561, H7-2908, H5-297506, 2002-145919, and the like.

As for the particle size distribution of the light-transmitting particles, monodisperse particles are preferred from the viewpoint of controlling a haze value and dispersibility and ensuring uniformity in a coating surface state. A CV value that indicates uniformity of particle diameters is preferably 15% or less, more preferably 13% or less, and still more preferably 10% or less. In addition, when a particle having a particle diameter of 20% or more larger than the average particle diameter is defined as a coarse particle, a ratio of the coarse particle is preferably 1% or less, more preferably 0.1% or less, and still more preferably 0.01% or less, based on the total number of particles. As for a particle having the particle size distribution, it is an effective unit to classify a particle having the particle size distribution after the preparation or synthesis reaction and it is possible to obtain a particles having a preferred distribution by increasing the number of classifications or strengthening the degree thereof.

For the classification, it is preferred to use a method such as an air classification method, a centrifugal classification method, a sedimentation classification method, a filtration classification method, and an electrostatic classification method.

[Polymerization Initiator]

The hardcoat-forming composition includes a polymerization initiator, and the polymerization initiator is preferably a photopolymerization initiator.

Examples of the photopolymerization initiator may include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, coumarins, and the like. Specific examples, preferred aspects, commercially available products, and the like of the photopolymerization initiator are described in paragraph Nos. [0133] to [0151] of Japanese Patent Application Laid-Open No. 2009-098658, and the same may be appropriately used likewise in the present invention.

Various examples of the photopolymerization initiator are described even in “Latest UV Curing Technology” {Technical Information Institute Co., Ltd.} (1991), p. 159 and “Ultraviolet Ray Curing System” written by Kiyomi Kato (1989, published by United Engineering Center), p. 65 to 148, and are useful for the present invention.

As for a commercially available photoradical polymerization initiator of photocleavage type, preferred examples thereof include “Irgacure 651”, “Irgacure 184”, “Irgacure 819”, “Irgacure 907”, “Irgacure 1870” (a CGI-403/Irgacure 184=7/3 mixed initiator), “Irgacure 500”, “Irgacure 369”, “Irgacure 1173”, “Irgacure 2959”, “Irgacure 4265”, “Irgacure 4263”, “Irgacure 127”, “OXE01” and the like, which are manufactured by Ciba Specialty Chemicals Inc.; “Kayacure DETX-S”, “Kayacure BP-100”, “Kayacure BDMK”, “Kayacure CTX”, “Kayacure BMS”, “Kayacure 2-EAQ”, “Kayacure ABQ”, “Kayacure CPTX”, “Kayacure EPD”, “Kayacure ITX”, “Kayacure QTX”, “Kayacure BTC”, “Kayacure MCA”, and the like, which are manufactured by Nippon Kayaku Co., Ltd.; Esacure (KIP100F, KB1, EB3, BP, X33, KTO46, KT37, KIP150, and TZT), and the like, which are manufactured by Sartomer Company Inc.; and a combination thereof.

The content of the photopolymerization initiator in the hardcoat layer-forming composition of the present invention is preferably 0.5% by mass to 8% by mass, and more preferably 1% by mass to 5% by mass, based on the total solid content of the hardcoat layer-forming composition, in order to set the content such that a polymerizable compound included in the hardcoat layer-forming composition is polymerized and an initiation point is not excessively increased.

[Solvent]

The hardcoat layer-forming composition of the present invention may contain a solvent. As for the solvent, various solvents may be used in consideration of solubility of a monomer, drying characteristic during the coating, dispersibility of light-transmitting particles and the like. Examples of the organic solvents may include dibutyl ether, dimethoxyethane, diethoxyethane, propylene oxide, 1,4-dioxane, 1,3-dioxolane, 1,3,5-trioxane, tetrahydrofuran, anisole, phenetole, dimethyl carbonate, methyl ethyl carbonate, diethyl carbonate, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetyl acetone, diacetone alcohol, methyl acetoacetate, ethyl acetoacetate, and the like, methyl alcohol, ethyl alcohol, isopropyl alcohol, n-butyl alcohol, cyclohexyl alcohol, isobutyl acetate, methyl isobutyl ketone (MIBK), 2-octanone, 2-heptanone, 2-hexanone, ethylene glycol ethyl ether, ethylene glycol isopropyl ether, ethylene glycol butyl ether, propylene glycol methyl ether, ethyl carbitol, butyl carbitol, hexane, heptane, octane, cyclohexane, methylcyclohexane, ethylcyclohexane, benzene, toluene, xylene, and the like. The organic solvents may be used either alone or in combination of two or more thereof.

When the transparent support is a cellulose acylate film, it is preferred to use at least one of dimethyl carbonate, methyl acetate, ethyl acetate, methyl ethyl ketone, acetyl acetone, and acetone, any of dimethyl carbonate and methyl acetate is more preferred, and methyl acetate is particularly preferred.

The solvent is used in such that a solid content concentration of the hardcoat-forming composition of the present invention is preferably 20% by mass to 80% by mass, more preferably 30% by mass to 75% by mass, and still more preferably 40% by mass to 70% by mass.

(Layer Configuration of Optical Film)

The hardcoat film of the present invention has a hardcoat layer on one surface of the transparent support, and a single or a plurality of necessary functional layers may be further formed thereon according to the purpose thereof. For example, it is possible to mount an antireflection layer (a layer, such as a low refractive index layer, an intermediate refractive index layer, a high refractive index layer, and the like, whose refractive index is adjusted, an antiglare layer, an antistatic layer, an ultraviolet absorption layer, and the like. The hardcoat layer may have antistatic property and UV absorption property.

More specific examples of the layer configuration of the optical film of the present invention will be shown below.

Transparent support/Hardcoat layer

Transparent support/Hardcoat layer/Overcoat layer

Transparent support/Hardcoat layer/Low refractive index layer

Transparent support/Hardcoat layer/High refractive index layer/Low refractive index layer

Transparent support/Hardcoat layer/Intermediate refractive index layer/High refractive index layer/Low refractive index layer

Transparent support/Hardcoat layer/Intermediate refractive index layer/High refractive index layer/Low refractive index layer/Antifouling layer

Transparent support/Hardcoat layer/Antiglare layer

Transparent support/Hardcoat layer/Antiglare layer/Low refractive index layer

Among the configurations, preferred is a configuration in which a low refractive index layer is formed on the outermost layer on the hardcoat layer side. The feeling of denseness of black is further improved by forming a low refractive index layer.

[Material for Low Refractive Index Layer]

Hereinafter, materials for the low refractive index layer will be described.

[Inorganic Particles]

It is preferred that inorganic particles are used in a low refractive index layer from the viewpoint of achieving low refractive index and improving scratch resistance. The inorganic particles are not particularly limited as long as the average particle size thereof is 5 nm to 120 nm, but inorganic low refractive index particles are preferred from the viewpoint of achieving low refractive index.

Examples of the inorganic particles include particles of magnesium fluoride or silica because of a low refractive index. In particular, silica particles are preferred in terms of a refractive index, dispersion stability, and costs. The size (primary particle diameter) of these inorganic particles is preferably 5 nm to 120 nm, more preferably 10 nm to 100 nm and 20 nm to 100 nm, and most preferably 30 nm to 90 nm.

When the particle diameter of the inorganic particles is excessively small, the effect of improving scratch resistance is low, and when the particle diameter is excessively large, fine unevenness is generated on the surface of the low refractive index layer, thereby worsening an appearance such as denseness of black and lowering an integral reflection ratio. In addition, in the case of using hollow silica particles to be described below, when the particle diameter thereof is excessively small, a ratio of a cavity portion is decreased such that sufficient reduction in refractive index may not be expected. The inorganic particles may be crystalline or amorphous, and may be monodispersed particles or may be aggregated particles as long as the inorganic particles satisfy a predetermined particle diameter. The morphology of the inorganic particles is most preferably spherical, but may be amorphous.

A coating amount of the inorganic particles is preferably 1 mg/m² to 100 mg/m², more preferably 5 mg/m² to 80 mg/m², and still more preferably 10 mg/m² to 60 mg/m². When the coating amount is excessively small, sufficient low refractive index may not be expected, or the effect of improving scratch resistance is reduced. When the coating amount is excessively large, fine unevenness is generated on the surface of the low refractive index layer, thereby worsening an appearance such as denseness of black and lowering an integral reflection ratio.

(Porous or Hollow Particles)

In order to achieve low refractive index, it is preferred that particles having a porous or hollow structure are used. It is particularly preferred that silica particles having a hollow structure are used. A porosity of these particles is preferably 10% to 80%, more preferably 20% to 60%, and most preferably 30% to 60%. It is preferred that the porosity of hollow particles is set to the above-described range from the viewpoint of achieving low refractive index and maintaining durability of particles.

When the porous or hollow particles are silica, the refractive index of the particles is preferably 1.10 to 1.40, more preferably 1.15 to 1.35, and most preferably 1.15 to 1.30. The refractive index herein represents a refractive index of entire particles, and does not represent a refractive index of only an outer shell silica forming silica particles.

The hollow silica may be used in combination of two or more of hollow silica having different particle average sizes. Here, the average particle diameter of the hollow silica may be obtained from an electron microscope photograph.

A specific surface area of the hollow silica in the present invention is preferably 20 mg/m² to 300 m²/g, more preferably 30 mg/m² to 120 m²/g, and most preferably 40 mg/m² to 90 m²/g. The surface area may be obtained by a BET method using nitrogen.

In the present invention, silica particles having no cavity may be used in combination of the hollow silica. A preferred particle size of the silica having no cavity is 30 nm to 150 nm, more preferably 35 nm to 100 nm, and most preferably 40 nm to 80 nm.

[Surface Treatment Method of Inorganic Particles]

Further, in the present invention, inorganic particles may be used after surface treatment with a silane coupling agent and the like by a typical method.

In particular, in order to improve the dispersibility in the binder for forming a low refractive index layer, it is preferred that the surface of the inorganic particle is treated with a hydrolysate of an organosilane compound and/or a partial condensate thereof, and it is more preferred that either one or both of an acid catalyst and a metal chelate compound are used during the treatment. The surface treatment method of the inorganic particles is described in Paragraph Nos. [0046] to [0076] of Japanese Patent Application Laid-Open No. 2008-242314, and the organosilane compound, the siloxane compound, the solvent for surface treatment, the catalyst for surface treatment, the metal chelate compound and the like, which are described therein, may also be suitably used in the present invention.

In the low refractive index layer, it is possible to use a fluorine-containing or nonfluorine-containing monomer (b2) having an ethylenically unsaturated double bond group. As the nonfluorine-containing monomer, it is preferred that the compounds having an ethylenically unsaturated double bond group, which is described as the compounds which may be used in the hardcoat layer, are also used. As the fluorine-containing monomer, it is preferred to use a fluorine-containing polyfunctional monomer (d) represented by the following Formula (1) and containing fluorine in an amount of 35% by mass or more, in which a calculated value of all inter-crosslinking molecular weights is less than 500.

Rf2{−(L)m−Y}n

(In Formula (1), Rf2 represents an n-valent group including at least a carbon atom and a fluorine atom, and n represents an integer of 3 or more. L represents a single bond or a divalent linking group, and m represents 0 or 1. Y represents an ethylenically unsaturated double bond group.)

Rf2 may include at least one of an oxygen atom and a hydrogen atom. In addition, Rf2 has a chain (straight or branched) structure or a cyclic structure.

Y is preferably a group including two carbon atoms forming an ethylenically unsaturated double bond, more preferably a radical polymerizable group, and particularly preferably a group selected from a (meth)acryloyl group, an allyl group, an α-fluoroacryloyl group, and —C(O)OCH═CH₂. Among them, a (meth)acryloyl group, an allyl group, an α-fluoroacryloyl group, and —C(O)OCH═CH₂, which have radical polymerizability, are more preferred from the viewpoint of polymerizability.

L represents a divalent linking group, specifically an alkylene group having 1 to 10 carbon atoms, an arylene group having 6 to 10 carbon atoms, —O—, —S—, —N(R)—, a group obtained by combining an alkylene group having 1 to 10 carbon atoms with —O—, —S— or —N(R)—, or a group obtained by combining an arylene group having 6 to 10 carbon atoms and —O—, —S— or —N(R)—. R represents a hydrogen atom or an alkyl group having 1 to 5 carbon atoms. When L represents an alkylene group or an arylene group, the alkylene group and the arylene group, which are represented by L, are preferably substituted with a halogen atom and preferably substituted with a fluorine atom.

Specific examples of the compound represented by Formula (1) are described in Paragraph Nos. [0121] to [0163] of Japanese Patent Application Laid-Open No. 2010-152311.

(Coating Method of Hardcoat Layer)

The hardcoat layer according to the hardcoat film of the present invention may be formed by the following method.

First, a hardcoat layer-forming composition is prepared. Subsequently, the composition is coated on a transparent support by a dip coating method, an air-knife coating method, a curtain coating method, a roller coating method, a wire bar coating method, a gravure coating method, a die coating method or the like, and is heated and dried. A micro gravure coating method, a wire bar coating method, and a die coating method (see the specification of U.S. Pat. No. 2,681,294 and Japanese Patent Laid-Open No. 2006-122889) are more preferred, and a die coating method is particularly preferred.

After being coated on the transparent support, the hardcoat layer is conveyed with a web to a heated zone for drying a solvent. At that time, a temperature in a drying zone is preferably 25° C. to 140° C. It is preferred that the temperature in the first half of the drying zone is at a relatively low level and the temperature in the second half of the drying zone is at a relatively high level. However, it is preferred that the temperature is equal to and lower than a temperature at which the components other than the solvent contained in the coating composition for each layer start to volatilize. For example, some of commercially available photoradical generators used in combination with a UV curable resin volatilize in an amount of approximately several tens % thereof within several minutes under a hot air condition of 120° C., and some of monofunctional or difunctional acrylate monomers and the like undergo volatilization under a hot air condition of 100° C. In such cases, it is preferred that the temperature is equal to or lower than a temperature at which the components other than the solvent contained in the coating composition for a hardcoat layer start to volatilize as described above.

In order to prevent the occurrence of drying unevenness, the drying air applied after coating the coating composition for a hardcoat layer on a base film is preferably 0.1 msec to 2 m/sec in air velocity on the surface of the coating film, in which the solid content concentration of the coating composition is 1% to 50%.

After coating the coating composition for a hardcoat layer on the base film, when the difference between the temperature of the base film and the temperature of a convey roll contacting with the surface of the base film opposite to the coated surface of the base film in the drying zone is 0° C. to 20° C., it is possible to prevent drying unevenness due to heat transfer unevenness on the convey roll, which is preferred.

After the drying zone of the solvent, the film is passed with a web through a zone where the hardcoat layer is cured by irradiation with ionized radiation, to cure the coating film. For example, when the coating film is UV curable, it is preferred to cure the coating film by irradiating an ultraviolet ray in an irradiation amount of 10 mJ/cm² to 1,000 mJ/cm² using an ultraviolet lamp. At that time, an irradiation amount distribution in the width direction of the web including both ends thereof is preferably 50% to 100% and more preferably 80% to 100%, based on the maximum irradiation amount at the center thereof. In addition, when it is necessary to reduce an oxygen concentration by purge with nitrogen gas or the like in order to accelerate surface curing, the oxygen concentration is preferably 0.01% to 5%, and the distribution thereof in the width direction is preferably 2% or less in terms of oxygen concentration. In the case of the ultraviolet ray irradiation, it is possible to use an ultraviolet ray emitted from a ray of light, such as a super high pressure mercury lamp, a high pressure mercury lamp, a low pressure mercury lamp, a carbon arc, a xenon arc, and a metal halide lamp. Further, in order to accelerate a curing reaction, the temperature at the curing may be increased, and is preferably 25° C. to 100° C., more preferably 30° C. to 80° C., and most preferably 40° C. to 70° C.

Other functional layers may be provided, if necessary. In the case of layering other functional layers in addition to the hardcoat layer, a plurality of layers may be coated simultaneously or sequentially. The method for fabricating other functional layers may be conducted in accordance with the method for fabricating the hardcoat layer.

[Polarizing Plate]

The hardcoat film of the present invention may be used at one side or both sides of protective films of a polarizing plate, which is composed of a polarization film and two protective films disposed on both sides thereof, thereby allowing the polarizing plate to have high surface hardness.

The hardcoat film of the present invention may be used as a protective film on one side and a typical cellulose acetate film may be used as a protective film on the other side, but it is also preferred that as the protective film on the other side, a cellulose acetate film prepared by a solution film forming method and stretched in the width direction in a roll film form at a stretching magnification of 10% to 100% is used.

Among the two protective films of the polarization film, it is also a preferred aspect that the film other than the hardcoat film of the present invention is an optically-compensatory film having an optically-compensatory layer including an optically anisotropic layer. The optically-compensatory film (phase difference film) may improve viewing angle characteristics of a liquid crystal display screen. A known optically-compensatory film may be used, but in terms of widening a viewing angle, the optically-compensatory film described in Japanese Patent Application Laid-Open No. 2001-100042 is preferred.

Examples of the polarization film may include an iodine-based polarization film, a dye-based polarization film using a dichroic dye, or a polyene-based polarization film. An iodine-based polarization film and a dye-based polarization film are generally prepared by using a polyvinyl alcohol-based film.

[Image Display Device]

The antiglare film or the polarizing plate of the present invention may be used for an image display device such as a liquid crystal display device (LCD), a plasma display panel (PDP), an electroluminescence display (ELD) or a cathode ray tube display device (CRT).

Hereinafter, characteristics of the present invention will be described in more detail with reference to Examples and Comparative Examples. The materials, the use amounts, the ratios, the treatment matters, the treatment sequences, and the like, which are shown in the following Examples, may appropriately be changed without departing from the spirit of the present invention. Therefore, the scope of the present invention should not be construed as being limited by the specific Examples shown below. Further, unless particularly specified, “parts” and “%” are based on mass. Hereinafter, a compound having a cyclic aliphatic hydrocarbon group and three or more ethylenically unsaturated double bond groups in a molecule thereof, which is used in the present invention, will be synthesized. The compound having a cyclic aliphatic hydrocarbon group and three or more ethylenically unsaturated double bond groups in a molecule thereof which is used in the present invention may be synthesized in the same manner.

(Synthesis of Compound A-2)

Into a reaction vessel equipped with a stirring device, a thermometer and a condenser, 9.8 g (0.05 mol) of tricyclodecanedimethanol (manufactured by Tokyo Chemical Industry Co., Ltd., molecular weight 196), 10 g of propyleneglycolmonomethylether acetate and 23.9 g (0.01 mol) of a diacrylate compound Karenz BEI (manufactured by Showa Denko K.K., molecular weight 239) were introduced, and 0.1 g of each of p-methoxyphenol and di-butyl-hydroxytoluene was introduced. After the mixture was heated to 60° C. while being stirred, the heating was stopped, and 0.02 g of dibutyl tin dilaurate was added thereto. The heating was initiated again when the temperature in the reaction vessel begun to drop, stirring was continued at 80° C., the reaction was terminated by confirming that the absorption spectrum (2280 cm⁻¹) of the isocyanate group had nearly disappeared by an infrared absorption spectrum, and extraction was performed with ethyl acetate from the reaction mixture, followed by drying to obtain acrylate compound A-2 (molecular weight 674).

(Synthesis of Compound A′-2)

Into a reaction vessel equipped with a stirring device, a thermometer, a condenser, and a nitrogen introducing tube, 9.8 g (0.05 mol) of tricyclodecanedimethanol (manufactured by Tokyo Chemical Industry Co., Ltd., molecular weight 196), 10 g of propyleneglycolmonomethylether acetate and 14.2 g (0.1 mol) of glycidyl methacrylate (manufactured by Tokyo Chemical Industry Co., Ltd., molecular weight 142) were introduced, and 0.1 g of each of p-methoxyphenol and di-butyl-hydroxytoluene was introduced. After the mixture was heated to 60° C. while being stirred, the heating was stopped, and 10 g of triethylamine was added thereto. The heating was initiated again under nitrogen flow, stirring was continued at 80° C., and 9.0 g (0.1 mol) of acrylic acid chloride (manufactured by Tokyo Chemical Industry Co., Ltd., molecular weight 90) was slowly added thereto to continue the reaction for 6 hours. Extraction was performed with ethyl acetate from the reaction mixture, followed by drying to obtain acrylate compound A′-2 (molecular weight 588).

It is possible to synthesize the compound having a cyclic aliphatic hydrocarbon group and three or more ethylenically unsaturated double bond groups in a molecule thereof, which is used in the present invention, in the same manner as in Compound A-2 and Compound A′2.

[Preparation of Hardcoat Layer-Forming Composition]

A coating solution for forming each layer shown below was prepared.

(Preparation of Hardcoat Layer-Forming Composition HC-1)

| | |
|---|---|
| Compound A-1 (100%) | 87.0 g |
| PET30 (100%) | 10.0 g |
| Irgacure 907 (100%) | 3.0 g |
| SP-13 | 0.04 g |
| MEK | 28.6 g |
| MIBK | 28.6 g |
| Methyl acetate | 24.5 g |

(Preparation of Hardcoat Layer-Forming Composition HC-2)

| | |
|---|---|
| Compound A-1 (100%) | 60.0 g |
| PET30 (100%) | 37.0 g |
| Irgacure 907 (100%) | 3.0 g |
| SP-13 | 0.04 g |
| MEK | 28.6 g |
| MIBK | 28.6 g |
| Methyl acetate | 24.5 g |

(Preparation of Hardcoat Layer-Forming Composition HC-3)

| | |
|---|---|
| Compound A-1 (100%) | 75.0 g |
| PET30 (100%) | 22.0 g |
| Irgacure 907 (100%) | 3.0 g |
| SP-13 | 0.04 g |
| MEK | 28.6 g |
| MIBK | 28.6 g |
| Methyl acetate | 24.5 g |

(Preparation of Hardcoat Layer-Forming Composition HC-4)

| | |
|---|---|
| Compound A-1 (100%) | 75.0 g |
| PET30 (100%) | 22.0 g |
| Irgacure 907 (100%) | 3.0 g |
| SP-13 | 0.04 g |
| MEK | 40.9 g |
| MIBK | 40.9 g |

(Preparation of Hardcoat Layer-Forming Composition HC-5)

| | |
|---|---|
| Compound A-1 (100%) | 97.0 g |
| Irgacure 907 (100%) | 3.0 g |
| SP-13 | 0.04 g |
| MEK | 40.9 g |
| MIBK | 40.9 g |

(Preparation of Hardcoat Layer-Forming Compositions HC-6 to 16)

Hardcoat layer-forming compositions HC-6 to HC-8 were prepared by changing A-1 in the hardcoat layer-forming composition HC-1 into A-2 to A-4, respectively. Likewise, hardcoat layer-forming compositions HC-9 to HC-12 were prepared by changing A-1 in the hardcoat layer-forming composition HC-1 into A′-1 to A′-4, respectively, hardcoat layer-forming compositions HC-13 to HC-15 were prepared by changing A-1 in the hardcoat layer-forming composition HC-1 into B-1 to B-3, respectively, and hardcoat layer-forming composition HC-16 was prepared by changing A-1 in the hardcoat layer-forming composition HC-1 into B′-3.

(Preparation of Hardcoat Layer-Forming Composition HC-17)

| | |
|---|---|
| A-DCP (100%) | 97.0 g |
| Irgacure 907 (100%) | 3.0 g |
| SP-13 | 0.04 g |
| MEK | 40.9 g |
| MIBK | 40.9 g |

(Preparation of Hardcoat Layer-Forming Composition HC-18)

| | |
|---|---|
| PET30 (100%) | 97.0 g |
| Irgacure 907 (100%) | 3.0 g |
| SP-13 | 0.04 g |
| MEK | 40.9 g |
| MIBK | 40.9 g |

A coating solution was prepared by filtering the hardcoat layer-forming composition with a propylene-made filter having a pore size of 30 μm.

Materials used are shown below.

PET-30: Mixture of pentaerythritol triacrylate and pentaerythritol tetraacrylate [manufactured by Nippon Kayaku Co., Ltd.]
A-DCP: Tricyclodecane dimethanol dimethacrylate (manufactured by Shin-Nakamura Chemical Co., Ltd.)
Irgacure 907: Polymerization initiator [manufactured by Ciba Specialty Chemicals Inc.]
Leveling agent (SP-13): Following fluorine polymer

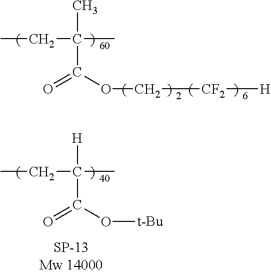

(Preparation of Coating Solution Ln-1 for Low Refractive Index Layer)

A low refractive index layer coating solution having a solid content of 5% by mass was prepared by mixing each component as follows, and dissolving the mixture in a 90/10 mixture (mass ratio) of MEK/MMPG-AC.

(Composition of Ln-1)

| | | |
|---|---|---|
| Following perfluoroolefin copolymer (P-1) | 15.0 | g |
| DPHA | 7.0 | g |
| RMS-033 | 5.0 | g |
| Following fluorine-containing monomer | 20.0 | g |
| Hollow silica particles (as a solid content) | 50.0 | g |
| Irgacure 127 | 3.0 | g |
| Compounds used are shown below. | | |

Perfluoroolefin copolymer (P-1) 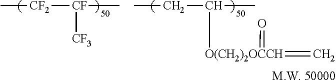
In the structural formula, 50:50 represents a molar ratio.
Fluorine-containing monomer (M-1)

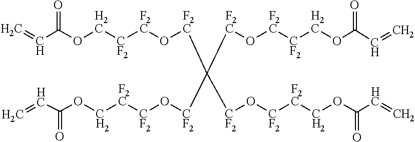 [SMILES: C=CC(=O)OCC(F)(F)C(F)(F)OC(F)(F)C(C(F)(F)OC(F)(F)C(F)(F)COC(=O)C=C)(C(F)(F)OC(F)(F)C(F)(F)COC(=O)C=C)C(F)(F)OC(F)(F)C(F)(F)COC(=O)C=C]

DPHA: Mixture of dipentaerythritol pentaacrylate and dipentaerythritol hexaacrylate (manufactured by Nippon Kayaku Co., Ltd.)
RMS-033: Silicone-based polyfunctional acrylate (manufactured by Gelest, Mwt=28,000)
Irgacure 127: Polymerization initiator, manufactured by Ciba Specialty Chemicals Inc.

Hollow silica: Hollow silica particle dispersion liquid (average particle size: 45 nm, refractive index: 1.25, the surface thereof having been subjected to a surface treatment with a silane coupling agent having an acryloyl group, and MEK dispersion liquid concentration: 20%)

MEK: Methyl ethyl ketone

MMPG-Ac: Propylene glycol monomethyl ether acetate

A coating solution was prepared by filtering the coating solution for a low refractive index layer with a propylene-made filter having a pore size of 1 μm. The refractive index after curing of the low refractive index layer obtained by coating and curing the coating solution Ln-1 for a low refractive index layer was 1.36.

[Fabrication of Hardcoat Film Sample] (Fabrication of Hardcoat Film Sample 101)

A FUJITAC TD60 (manufactured by Fujifilm Corporation, width 1,340 mm, thickness 60 μm) was unwound from the roll form, and coated with the coating solution HC-1 for a hardcoat layer by a die coating method using a slot die, which is described in Example 1 of Japanese Patent Application Laid-Open No. 2006-122889, under a condition at a conveying velocity of 30 m/min. After being dried at 60° C. for 150 seconds, the coated layer was further cured by irradiating ultraviolet rays at an illuminance of 400 mW/cm² and an irradiation dose of 300 mJ/cm² using an air-cooled metal halide lamp of 160 W/cm (manufactured by Eye Graphics Co., Ltd.) at an oxygen concentration of about 0.1% while purging with nitrogen, followed by winding up the film. The coating amount was adjusted such that the film thickness of the hardcoat layer is 8 μM.

[Fabrication Hardcoat Film Sample]

(Fabrication of Hardcoat Film Samples 102 to 119)

Hardcoat film samples 102 to 118 were prepared by changing the coating solution for a hardcoat layer from HC-1 into HC-2 to HC-18 for the hardcoat film sample 101.

In addition, the hardcoat film in which the hardcoat layer was not layered was defined as hardcoat film sample 119.

(Fabrication of Antireflection Film Sample 120)

A FUJITAC TD60 (manufactured by Fujifilm Corporation, width 1,340 mm, thickness 60 μm) was unwound from the roll form, and coated with the coating solution HC-9 for a hardcoat layer by a die coating method using a slot die, which is described in Example 1 of Japanese Patent Application Laid-Open No. 2006-122889, under a condition at a conveying velocity of 30 m/min. After being dried at 60° C. for 150 seconds, the coated layer was further cured by irradiating ultraviolet rays at an illuminance of 600 mW/cm² and an irradiation dose of 60 mJ/cm² using an air-cooled metal halide lamp of 160 W/cm (manufactured by Eye Graphics Co., Ltd.) at an oxygen concentration of about 0.1% while purging with nitrogen, followed by winding up the film. The coating amount was adjusted such that the film thickness of the hardcoat layer was 8 μm.

The hardcoat film fabricated above was unwound from the roll form, and the coating solution Ln-1 for a low refractive index layer was coated on the side on which the hardcoat layer was coated and formed, thereby fabricating antireflection film sample 120. A drying condition of the low refractive index layer was controlled at 60° C. for 60 seconds. A curing condition with ultraviolet rays was controlled at an illuminance of 600 mW/cm² and an irradiation dose of 300 mJ/cm² using an air-cooled metal halide lamp of 240 W/cm (manufactured by Eye Graphics Co., Ltd.) while purging with nitrogen so as to be an atmosphere of an oxygen concentration of 0.1% by volume or less. The low refractive index layer has a refractive index of 1.36, and a film thickness of 95 nm.

Various characteristics of the hardcoat films fabricated above were measured by the following methods.

(Measurement of Characteristics of Optical Film)

(1) Specular Reflectance

The specular spectral reflectance of each antiglare hardcoat film sample at an incident angle of 5° was measured in a wavelength region of 380 nm to 780 nm using a spectrophotometer (manufactured by JASCO Corporation). An average reflectance at a wavelength of 450 to 650 nm was used in evaluation.

(2) Moisture Permeability (Moisture Permeability at 40° C. and 90% Relative Humidity)

Moisture permeability was measured by the following method. The films in the present invention were cut so as to be circle form with a diameter of 70 mm, and each film was conditioned at 40° C. and 90% RH for 24 hours. And then, the moisture contents (g/m²) per unit area were calculated as moisture permeability=mass after moisture conditioning−mass before moisture conditioning, using a moisture permeation cup in accordance with JIS Z-0208.

(3) Pencil Hardness Evaluation

The pencil hardness evaluation described in JIS K 5400 was conducted as an index of scratch resistance. A light diffusing film was moisture conditioned at a temperature of 25° C. and a humidity of 60% RH for 2 hours, and then the test was performed under a load of 4.9N, using a 2 H to 5 H test pencil as set forth in JIS S 6006 and evaluated as the following criteria. The highest hardness at which an “OK” rating was given was defined as the evaluation value.

OK: 3 or more of no scratch in evaluation of n=5

NG: 2 or less of no scratch in evaluation of n=5

(4) Adhesion Evaluation

On the surface at the side of the optical film having the hardcoat layer, incisions were made with a cutter knife in a grid pattern of 11 lines long by 11 lines wide, thereby carving 100 square blocks in total. A polyester adhesive tape “NO.31B” manufactured by Nitto Denko Corporation was stuck thereto by application of pressure by performing an adhesion test, and whether some of the squares were peeled off or not was confirmed and observed by the eyes.

When the peel-off occurred in less than 20 cells out of the 100 blocks, an adhesion test was performed at the same place. A repeated test was performed maximally two times. After observing by the eyes whether some of the squares were peeled off, the following 5-step evaluation was performed. The results are shown in Table 2.

A: No peel-off is recognized in 100 blocks in an adhesion test performed two times

B: 1 to 5 cells are peeled off in 100 blocks in an adhesion test performed two times

C: 6 to 19 cells are peeled off in 100 blocks in an adhesion test performed two times

D: 20 cells or more are peeled off in 100 blocks in an adhesion test performed two times

E: 20 cells or more are peeled off in 100 blocks in an adhesion test performed one time

### [Surface Saponification Treatment of Film]

Hardcoat films 101 to 119, an antireflection film 120, a commercially available cellulose acylate film ZRD40 (manufactured by Fujifilm Corporation), and a commercially available cellulose acylate film TD60 (manufactured by Fujifilm Corporation) were immersed in a sodium hydroxide aqueous solution at 2.3 mol/L at 55° C. for 3 minutes. The films were washed with water in a water-washing bath at room temperature and neutralized at 30° C. using sulfuric acid at 0.05 mol/L. The films were washed again with water in the water-washing bath at room temperature, and dried with hot wind at 100° C. As described above, the films were subjected to surface saponification treatment.

(Fabrication of Front-Side Polarizing Plates 101 to 120)

A surface of hardcoat films 101 to 119 and antireflection film 120 after the saponification on which a hardcoat layer was not layered, a stretched iodine-based PVA polarizer, and the cellulose acylate film ZRD40 after saponification were bonded in this order using a PVA type adhesion bond, and thermally dried to obtain polarizing plates 101 to 121.

At this time, the longitudinal direction of the roll of the fabricated polarizer and the longitudinal direction of hardcoat films 101 to 119 and antireflection film 120 were disposed to be parallel with each other. Further, the longitudinal direction of the roll of the polarizer and the longitudinal direction of the roll of the cellulose acylate film ZRD40 were disposed to be parallel with each other.

(Fabrication of Rear-Side Polarizing Plate)

The aforementioned cellulose acylate film TD60 after saponification, the stretched iodine-based PVA polarizer, and the cellulose acylate film ZRD40 after saponification were bonded in this order using a PVA type adhesion bond, and thermally dried to obtain a rear-side polarizing plate.

At this time, the longitudinal direction of the roll of the fabricated polarizer and the longitudinal direction of cellulose acylate film TD60 were disposed to be parallel with each other. In addition, the longitudinal direction of the roll of the polarizer and the longitudinal direction of the roll of the cellulose acylate film ZRD40 were disposed to be parallel with each other.

[Fabrication of Liquid Crystal Display Device]

Two polarizing plates of a commercially available IPS-type liquid crystal television (42LS5600 manufactured by LG Electronics) were peeled off, and the above-described polarizing plates 101 to 120 as a front-side polarizing plate on the front side and the above-described polarizing plate as a rear-side polarizing plate on the rear side were adhered with each one sheet to the front side and the rear side through an adhesive such that the cellulose acylate film ZRD40 was each on a liquid crystal cell side. The crossed Nichol was disposed such that the absorption axis of the polarizing plate on the front side was in the longitudinal direction (crosswise direction) and the transmission axis of the polarizing plate on the rear side is in the longitudinal direction (crosswise direction). The thickness of glass used in the liquid crystal cell was 0.5 mm.

Thus, liquid crystal display devices 101 to 120 were obtained.

[Light Leakage Evaluation]

The liquid crystal display devices 101 to 120 thus fabricated were subjected to thermo treatment at 60° C. and 90% relative humidity for 48 hours and then left to stand at 25° C. and 60% relative humidity for 2 hours, the backlights of the liquid crystal display devices were turned on, and light leakage at the four corners of the panel was evaluated 5 hours and 10 hours after the backlight is turned on.

As for the light leakage evaluation, a black display screen was captured in front of the screen with a camera for measuring luminance “ProMetric” (manufactured by Radiant Imaging Inc.), and then a 7-step evaluation is performed based on the difference between the average luminance of the entire screen and the luminance at a site where the light leakage at the four corners was high.

˜Evaluation Index˜

A: Light leakage is not recognized at the four corners of the panel after 5 hours.
Light leakage is not recognized at the four corners of the panel after 10 hours.

B: Slight light leakage is recognized at 1 to 2 corners in the four corners of the panel after 5 hours, but is within an allowable range.
Light leakage is not recognized at the four corners of the panel after 10 hours.

C: Slight light leakage is recognized at 1 to 2 corners in the four corners of the panel after 5 hours, but is within an allowable range.
Slight light leakage is recognized at 1 to 2 corners in the four corners of the panel after 10 hours, but is within an allowable range.

D: Slight light leakage is recognized at 3 to 4 corners in the four corners of the panel after 5 hours, but is within an allowable range.
Slight light leakage is recognized at 1 to 2 corners in the four corners of the panel after 10 hours, but is within an allowable range.

E: Slight light leakage is recognized at 3 to 4 corners in the four corners of the panel after 5 hours, but is within an allowable range.
Slight light leakage is recognized at 3 to 4 corners in the four corners of the panel after 10 hours, but is within an allowable range.

F: Light leakage at the four corners of the panel after 5 hours is too strong to be allowable.
Slight light leakage is recognized at 3 to 4 corners in the four corners of the panel after 10 hours.

G: Light leakage at the four corners of the panel after 5 hours is too strong to be allowable.
Light leakage at the four corners of the panel after 10 hours is too strong to be allowable.

TABLE 1

| | Film sample | | | | | | | | | |
|---|---|---|---|---|---|---|---|---|---|---|
| | 101 | 102 | 103 | 104 | 105 | 106 | 107 | 108 | 109 | 110 |
| | Example | Example | Example | Example | Example | Example | Example | Example | Example | Example |
| Reflectance | 4.5% | 4.5% | 4.5% | 4.5% | 4.5% | 4.5% | 4.5% | 4.5% | 4.5% | 4.5% |
| Pencil hardness | 3H | 3H | 3H | 3H | 3H | 3H | 3H | 3H | 3H | 3H |
| Moisture | 93 | 98 | 95 | 94 | 90 | 95 | 91 | 91 | 89 | 89 |
| permeability | | | | | | | | | | |
| (g/m² · day) | | | | | | | | | | |
| Adhesion | A | A | A | A | B | A | A | A | A | A |
| Light leakage | B | C | B | B | A | B | B | B | A | A |

TABLE 2

| | Film sample | | | | | | | | | |
|---|---|---|---|---|---|---|---|---|---|---|
| | | | | | | | 117 | 118 | 119 | |
| | 111 | 112 | 113 | 114 | 115 | 116 | Comp. | Comp. | Comp. | 120 |
| | Example | Example | Example | Example | Example | Example | Ex. | Ex. | Ex. | Example |
| Reflectance | 4.5% | 4.5% | 4.2% | 4.5% | 4.5% | 4.5% | 4.5% | 4.4% | 4.0% | 1.1% |
| Pencil hardness | 3H | 3H | 3H | 3H | 3H | 3H | H | 3H | — | 3H |
| Moisture permeability | 85 | 85 | 90 | 89 | 93 | 90 | 130 | 300 | 550 | 88 |
| (g/m² · day) | | | | | | | | | | |
| Adhesion | A | A | A | A | A | A | B | A | — | A |
| Light leakage | A | A | A | A | B | A | F | G | G | A |

The following matters are apparent from the results shown in Tables 1 and 2.

1. Since the hardcoat layer formed of a hardcoat layer-forming composition including a compound having a cyclic aliphatic hydrocarbon group and three or more ethylenically unsaturated double bond groups in a molecule thereof has low water vapor permeability and high pencil hardness, it is difficult for light leakage to occur.

2. Light leakage corresponds to moisture permeability, and the lower the moisture permeability is, the more difficult it for light leakage is to occur.

3. The hardcoat layer has much better adhesion as well as low moisture permeability by using a (meth)acrylate compound having no cyclic aliphatic hydrocarbon group in combination with a compound having a cyclic aliphatic hydrocarbon group and three or more ethylenically unsaturated double bond groups in a molecule thereof in the hardcoat layer-forming composition.

4. In an antireflection film in which an antireflection layer is layered on the hardcoat layer, moisture permeability is low and pencil hardness is high such that it is difficult for light leakage to occur, and reflectance is also low such that reflection of an image is low when the antireflection film is used in a liquid crystal display device. It is also a preferred aspect to layer an antireflection layer on the hardcoat film of the present invention and use the layered body.

Hereinafter, an Example in which an acrylic (meth)acrylic polymer type transparent support is used as the transparent support will be described.

<Fabrication of Acrylic Transparent Support 1>

Into a reaction tank having an internal volume of 30 L equipped with a stirring device, a temperature sensor, a cooling tube, and a nitrogen introducing tube, 8,000 g of methyl methacrylate (MMA), 2,000 g of 2-(hydroxymethyl)methyl acrylate (MHMA), and 10,000 g of toluene as a polymerization solvent were charged, and the temperature was increased to 105° C. while nitrogen was passed therethrough. When reflux accompanied by an increase in temperature started, 10.0 g of t-amylperoxyisononanoate as a polymerization initiator was added thereto, and simultaneously, a solution constituted by 20.0 g of t-amylperoxyisononanoate and 100 g of toluene was added dropwise over 2 hours so that the mixture was subjected to solution polymerization under reflux at about 105 to 110° C., and then the mixture was also aged for 4 hours. The polymerization reaction rate was 96.6%, and the content (a weight ratio) of MHMA in the obtained polymer was 20.0%.

Subsequently, 10 g of a stearyl phosphate/distearyl phosphate mixture (Phoslex A-18, manufactured by Sakai Chemical Industry Co., Ltd.) as a cyclization catalyst was added into the polymer solution thus obtained, so that the resulting mixture was subjected to cyclocondensation reaction under reflux at about 80° C. to 100° C. for 5 hours.

Subsequently, the obtained polymer solution was introduced into a vent type screw biaxial extruder (screw diameter φ=29.75 mm, effective length L/D=30), which had a barrel temperature of 260° C., a rotation speed of 100 rpm, and a decompression degree of 13.3 to 400 hPa (from 10 to 300 mmHg) and was equipped with one rear vent and four fore vents, at a processing rate of 2.0 kg/h in terms of the resin amount, and was subjected to cyclocondensation reaction and devolatilization in the extruder. Subsequently, after the devolatilization was completed, the thermally melted resin remaining in the extruder was extruded from the end of the extruder and then pelletized by a pelletizer, and a transparent pellet made of an acrylic resin having a lactone ring structure in the main chain thereof was obtained. This resin had a weight average molecular weight of 148,000, a melt flow rate (which is measured in accordance with JIS K7120 at a test temperature of 240° C. and under a load of 10 kg, and the melt flow rates were also measured in the same manner in the following Preparation Examples) of 11.0 g/10 min, and a glass transition temperature of 130° C.

Subsequently, a transparent pellet having a glass transition temperature of 127° C. was obtained by kneading the pellet obtained and an AS resin (trade name: TOYO AS AS 20, manufactured by TOYO STYRENE Co., Ltd.) using a uniaxial extruder (screw diameter φ=30 mm) at a weight ratio of pellet/AS resin=90/10.

The pellet of the resin composition fabricated above was melted and extruded from a coat hanger type T-die using a biaxial extruder to fabricate a resin film having a thickness of about 160 μm.

Subsequently, a transparent plastic film support was fabricated by simultaneously biaxially stretching the unstretched resin film obtained by 2.0 times in a longitudinal direction and by 2.0 times in a transverse direction. The biaxially stretched film thus obtained had a thickness of 40 μm, a total light transmittance of 92%, a haze of 0.3%, and a glass transition temperature of 127° C.

<Fabrication of Acrylic Transparent Support 2>

Into a reaction tank having an internal volume of 30 L equipped with a stirring device, a temperature sensor, a cooling tube, and a nitrogen introducing tube, 41.5 parts of methyl methacrylate (MMA), 6 parts of 2-(hydroxymethyl)methyl acrylate (MHMA), 2.5 parts of 2-[2′-hydroxy-5′-methacryloyloxy]ethylphenyl]-2H-benzotriazole (trade name: RUVA-93, manufactured by Otsuka Chemical Co., Ltd.), 50 parts of toluene as a polymerization solvent, 0.025 parts of an antioxidant (ADEKA STAB 2112 manufactured by Asahi Denka Kogyo K.K.), and 0.025 parts of n-dodecyl mercaptan as a chain transfer agent were put, and the temperature was increased to 105° C. while nitrogen was passed therethrough. When reflux accompanied by an increase in temperature stars, 0.05 parts of t-amylperoxyisononanoate (trade name: Luperox 570 manufactured by ARKEMA YOSHITOMI, LTD.) as a polymerization initiator was added thereto, and simultaneously, 0.10 parts of t-amylperoxyisononanoate was added dropwise over 3 hours so that the mixture was subjected to solution polymerization under reflux at about 105 to 110° C., and then the mixture was also aged for 4 hours.

Subsequently, the polymerization solution obtained was subjected to cyclocondensation reaction under reflux at about 90 to 110° C. for 2 hours by adding 0.05 parts of 2-ethylhexyl phosphate (Phoslex A-8 manufactured by Sakai Chemical Industry Co., Ltd.) as a catalyst (cyclization catalyst) of cyclocondensation reaction thereto, and then was further subjected to cyclocondensation reaction by heating the polymerization solution for 30 minutes by an autoclave at 240° C. Subsequently, 0.94 parts of CGL777MPA (manufactured by Ciba Specialty Chemicals Inc.) was mixed as a UV absorbing agent with the polymerization solution after the reaction.

Subsequently, the obtained polymer solution was introduced into a vent type screw biaxial extruder (screw diameter φ=50.0 mm, effective length L/D=30), which had a barrel temperature of 240° C., a rotation speed of 100 rpm, and a decompression degree from 13.3 to 400 hPa (from 10 to 300 mmHg) and was equipped with one rear vent, four fore vents (referred to first, second, third, and fourth vents from the upstream side), and a leaf disk-type polymer filter (filtration accuracy: 5 μm, filtration area: 1.5 m²) disposed at an end portion thereof, at a processing rate of 45 kg/h in terms of the resin amount, and was subjected to devolatilization. At that time, a separately prepared mixed solution of an antioxidant and a cyclization catalyst deactivator was introduced thereinto at an introduction rate of 0.68 kg/h after the first vent, and ion-exchanged water was introduced thereinto at an introduction rate of 0.22 kg/h after the third vent.

As the mixed solution of an antioxidant and a cyclization catalyst deactivator, a solution obtained by dissolving 50 parts of antioxidant (SUMILIZER GS, manufactured by Sumitomo Chemical Industry Co., Ltd.) and 35 parts of zinc octoate as the deactivator (3.6% Nikka Octhix Zinc manufactured by NIHON KAGAKU SANGYO Co., Ltd.) in 200 parts of toluene was used.

Subsequently, after the devolatilization was completed, the thermally melted resin remaining in the extruder was extruded from the end of the extruder while being accompanied by the filtration of the polymer filter, and then pelletized by a pelletizer, and a pellet of a transparent resin composition including an acrylic resin having a lactone ring structure in the main chain thereof and a UV absorbing agent was obtained. The weight average molecular weight of the resin was 145,000, and the glass transition temperature (Tg) of the resin and the resin composition was 122° C.

The pellet of the resin composition fabricated above was melted and extruded from a coat hanger type T-die using a biaxial extruder to fabricate a resin film having a thickness of about 160 μm.

Subsequently, a transparent plastic film support was fabricated by simultaneously biaxially stretching the unstretched resin film obtained by 2.0 times in a longitudinal direction and by 2.0 times in a transverse direction.

Physical properties of the biaxially stretched resin film thus obtained were measured, and as a result, the thickness was 40 mm, the haze (turbidity) was 0.3%, the glass transition temperature was 128° C., the transmittance to light with a wavelength of 380 nm was 5.8%, and the transmittance to light with a wavelength of 500 nm was 92.2%.

Hardcoat films 201 to 203 were fabricated in the same manner as in the hardcoat films 101 to 103 fabricated above, except that the transparent support was changed into acrylic transparent support 1.

Hardcoat films 204 to 206 were fabricated in the same manner as in the hardcoat films 101 to 103, except that the transparent support was changed into acrylic transparent support 2.

(Fabrication of Front-Side Polarizing Plates 201 to 206)

A surface of the aforementioned hardcoat films 201 to 206 after saponification of which the hardcoat layers were not layered was subjected to corona treatment, and then bonded to a stretched iodine-based PVA polarizer using an acrylic adhesion bond. Subsequently, the cellulose acylate film ZRD40 after saponification was bonded to a surface on which the hardcoat film of the iodine-based PVA polarizer stretched with a PVA type adhesion bond was not bonded, and then thermally dried to obtain polarizing plates 201 to 206.

At this time, the longitudinal direction of the roll of the fabricated polarizer and the longitudinal direction of hardcoat films 201 to 206 were disposed to be parallel with each other. Further, the longitudinal direction of the roll of the polarizer and the longitudinal direction of the roll of the cellulose acylate film ZRD40 were disposed to be parallel with each other.

[Fabrication of Liquid Crystal Display Device]

Liquid crystal display devices 201 to 206 were fabricated by changing the polarizing plate adhered to the aforementioned liquid crystal display device 101 from polarizing plate 101 to polarizing plates 201 to 206.

Light leakage of the fabricated liquid crystal display devices 201 to 206 after thermo treatment was evaluated in the same manner as in the liquid crystal display device 101. The results are shown in Table 3.

TABLE 3

| | Film sample | | | | | |
|---|---|---|---|---|---|---|
| | 201 | 202 | 203 | 204 | 205 | 206 |
| | Example | Example | Example | Example | Example | Example |
| Reflectance | 4.5% | 4.5% | 4.5% | 4.5% | 4.5% | 4.5% |
| Pencil hardness | 3H | 3H | 3H | 3H | 3H | 3H |
| Moisture permeability | 52 | 54 | 53 | 53 | 55 | 54 |
| (g/m² · day) | | | | | | |
| Adhesion | A | A | A | A | A | A |
| Light leakage | A | A | A | A | A | A |

The following matters are apparent from the results shown in Table 3.

1. The hardcoat layer formed of a hardcoat layer-forming composition including a compound having a cyclic aliphatic hydrocarbon group and three or more ethylenically unsaturated double bond groups in a molecule thereof is formed in an acrylic support and thus has low moisture permeability and high pencil hardness, so that it is difficult for light leakage to occur.

2. Since the hardcoat layer using an acrylic support has a lower moisture permeability than that of a hardcoat layer using a cellulose acylate support, it is further difficult for light leakage to occur.

What is claimed is:

1. A hardcoat film comprising:
a hardcoat layer provided at least one surface-side of a transparent support,
wherein the hardcoat layer is formed from a hardcoat layer-forming composition containing a compound having a cyclic aliphatic hydrocarbon group and three or more ethylenically unsaturated double bond groups in a molecule of the compound, and a polymerization initiator.

2. The hardcoat film according to claim 1,
wherein the cyclic aliphatic hydrocarbon group is a group represented by Formula (I), (II) or (IV): 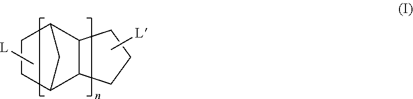
wherein in Formula (I), each of L and L′ independently represents a di- or higher valent linking group, and both L and L′ are not divalent at the same time, and n represents an integer of 1 to 3: 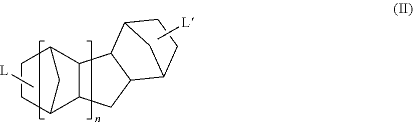
wherein in Formula (II), each of L and L′ independently represents a di- or higher valent linking group, and both L and L′ are not divalent at the same time, and n represents an integer of 1 to 2: 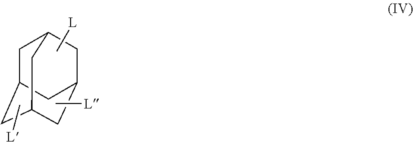
wherein in Formula (IV), each of L, L′ and L″ independently represents a di- or higher valent linking group.

3. The hardcoat film according to claim 1,
wherein the compound having a cyclic aliphatic hydrocarbon group and three or more unsaturated double bond groups is a compound represented by any of Formulae A-1, A-2, A-3, A-4, A′-1, A′-2, A′-3, A′-4, B-1, B-2, B-3, and B′-3.

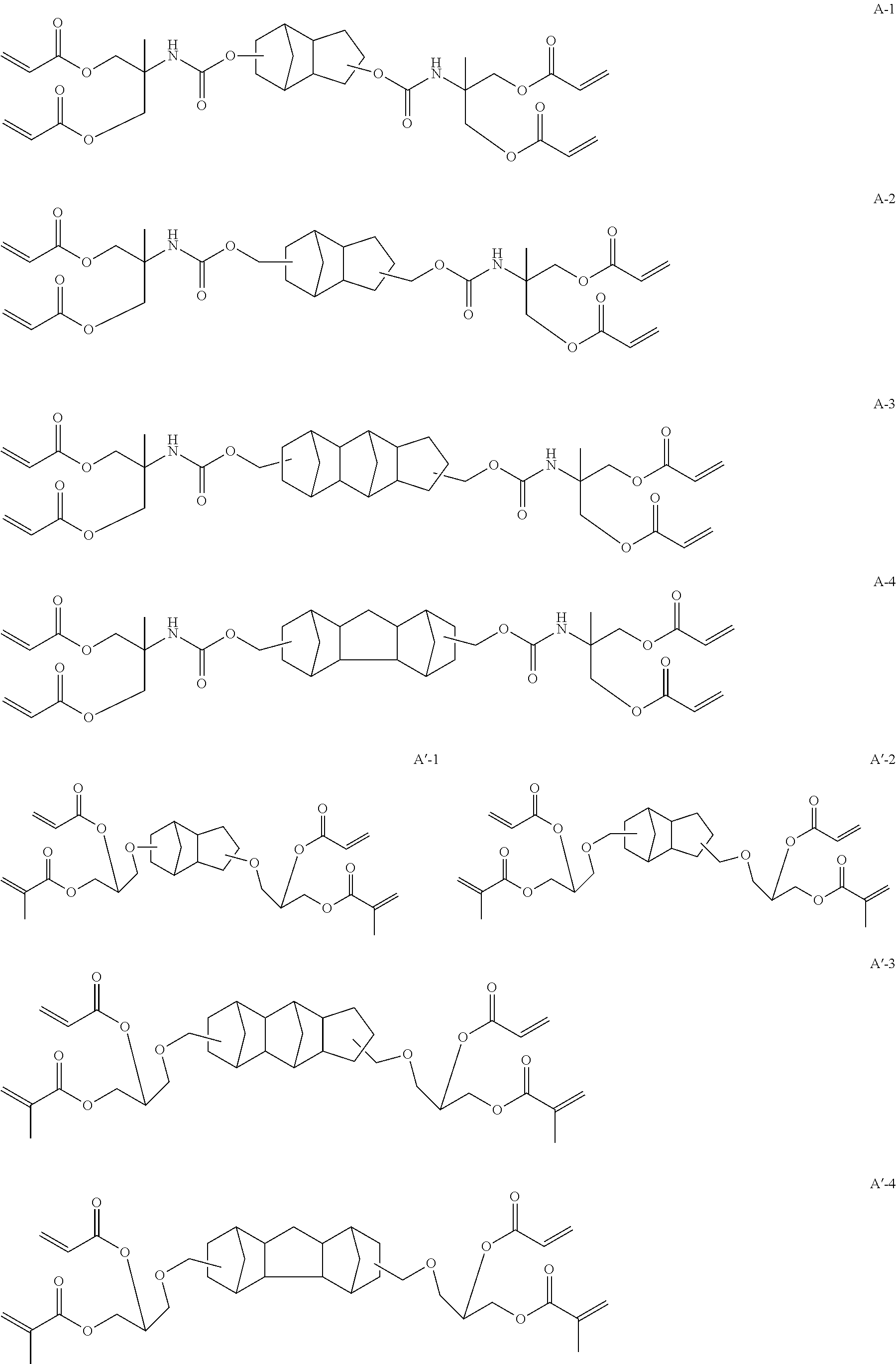

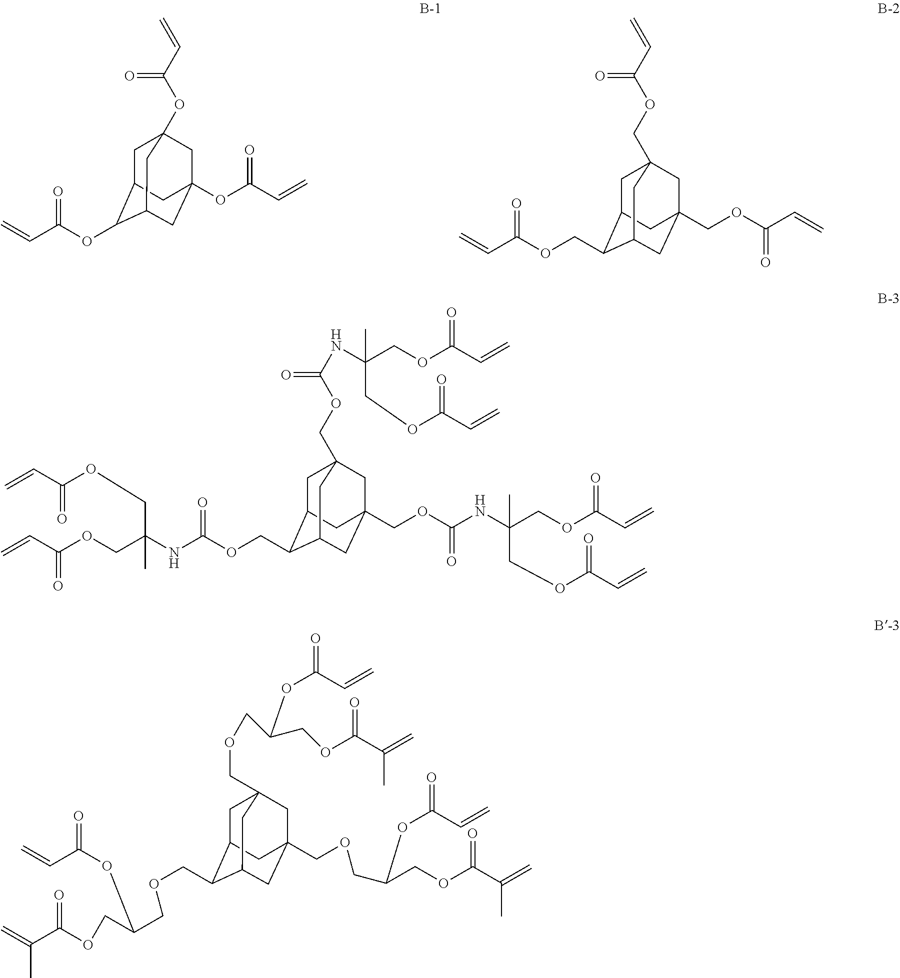

4. The hardcoat film according to claim 1,
wherein the cyclic aliphatic hydrocarbon group is the group represented by Formula (I).

5. The hardcoat film according to claim 1,
wherein a content of the compound having a cyclic aliphatic hydrocarbon group and three or more unsaturated double bond groups is 60% by mass to 99% by mass based on a solid content except for inorganic components in the hardcoat layer-forming composition.

6. The hardcoat film according to claim 1,
wherein the hardcoat layer-forming composition contains a (meth)acrylate compound having no cyclic aliphatic hydrocarbon group in an amount of 5% by mass to 20% by mass based on a solid content except for inorganic components in the hardcoat layer-forming composition.

7. The hardcoat film according to claim 1,
wherein the transparent support is a thermoplastic resin film including a (meth)acrylic polymer as a main component.

8. The hardcoat film according to claim 7,
wherein the (meth)acrylic polymer is a polymer having at least one selected from the group consisting of a lactone ring structure, an anhydrous glutaric acid ring structure and a glutarimide ring structure, in a main chain of the polymer.

9. The hardcoat film according to claim 7,
wherein the (meth)acrylic polymer is a polymer having a unit represented by Formula (A): 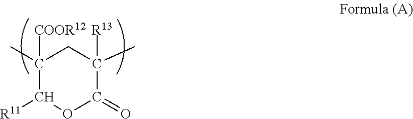
wherein in Formula (A), each of R¹¹, R¹², and R¹³ independently represents a hydrogen atom or an organic residue having 1 to 20 carbon atoms, and the organic residue may contain an oxygen atom.

10. The hardcoat film according to claim 1,
wherein the transparent support is a cellulose acylate film.

11. A method for fabricating the hardcoat film according to claim 1, the method comprising:
forming a hardcoat layer with a hardcoat layer-forming composition containing a compound having a cyclic aliphatic hydrocarbon group and three or more ethylenically unsaturated double bond groups in a molecule of the compound, and a polymerization initiator on at least one surface-side of a transparent support.

12. An antireflection film comprising:
the hardcoat film according to claim 1; and
a low refractive index layer with lower refractive index than the transparent support,
wherein the low refractive index is provided on a side of the hardcoat layer opposite to the transparent support.

13. A polarizing plate comprising the hardcoat film according to claim 1.

14. A polarizing plate comprising the antireflection film according to claim 12.

15. An image display device comprising the hardcoat film according to claim 1.

16. An image display device comprising the antireflection film according to claim 12.

17. An image display device comprising the polarizing plate according to claim 13.
